(19) United States
(12) Patent Application Publication
(10) Pub. No.: US 2025/0067465 A1
(43) Pub. Date: Feb. 27, 2025

(54) Fluid Flow Augmenting Device for a Fluid Circulation System

(71) Applicant: 2874108 Ontario Limited, Sarnia (CA)

(72) Inventors: Paul CAMPBELL, Sarnia (CA); Derek SHANNON, Sarnia (CA); Darren HAKKER, Sarnia (CA); L. Richard WILLISTON, London (CA)

(73) Assignee: 2874108 Ontario Limited, Sarnia, ON (CA)

(21) Appl. No.: 18/723,606

(22) PCT Filed: Dec. 23, 2022
(86) PCT No.: PCT/CA2022/051898

§ 371 Date: Jun. 24, 2024

Related U.S. Application Data
(60) Provisional application No. 63/293,732, filed on Dec. 24, 2021.
(60) Provisional application No. 63/364,336, filed on May 6, 2022.

(51) Int. Cl. F24F 13/08; F28D 1/02; F28F 25/12

(52) U.S. Cl. CPC F24F 13/08; F28D 1/024; F28F 25/12

(57) ABSTRACT

The present disclosure provides a fluid flow augmenting device to augment a fluid flow in any fluid circulation system without significant additional power consumption. The device includes an annular body extending along a longitudinal axis and defining an internal volume. The annular body includes a fluid inlet on one longitudinal end and a fluid outlet on another end and a first and second fluid directing structures. The first fluid directing structure receives a first fluid flow with a first fluid flow rate from a fluid source via the fluid inlet while the second fluid directing structure induces a second fluid flow with a second fluid flow rate from around the device to combine with the first fluid flow and generate an augmented fluid flow having an augmented fluid flow rate to be exhausted via the fluid outlet.

### CROSS REFERENCE TO PRIOR APPLICATIONS

The present application claims priority from U.S. Patent Application No. 63/293,732, filed Dec. 24, 2021, and U.S. Patent Application No. 63/364,336, filed May 6, 2022. The contents of these prior applications are incorporated herein by reference as if set forth in their entirety.

### TECHNICAL FIELD

The present disclosure relates to a fluid circulation system, such as a heating, ventilation, and air conditioning (HVAC) system or a cooling tower, and a fluid flow augmenting device for use in such a fluid circulation system.

### BACKGROUND

Many fluid circulation systems, such as air conditioners, HVAC systems, cooling towers, vehicular HVAC systems, refrigeration systems, industrial freezers, and so on, are widely used in various residential and/or industrial or commercial applications. These systems generally operate to provide conditioning (e.g., heating, cooling, filtration, dehumidification, etc.) to their corresponding environments. With a growing increase in demand for such systems, there is a growing concern vis-à-vis their capacities, costs, and their environmental sustainability. There have been many technological developments to enhance such systems and meet government regulations of providing more cost-effective and energy-efficient solutions to cater to such wide utilization.

For example, residential air conditioning systems generally use a series of copper coils in an outdoor condenser to cool hot refrigerant and air entrained by a fan atop the condenser assists in this process. Generally, the air that enters the condenser is equivalent to the air that exits through the fan and the cooled refrigerant is delivered to an indoor air conditioning unit, and then returned to an outdoor unit to cool once again. Most of the current technological developments to improve, for example, such air conditioning systems, often focus on improving the efficiency and performance of the existing components within such systems, such as fan blades/motors, demand-based control system enhancements and energy analysis software upgrades, etc. However, there have not been many efforts driven towards improving fluid flow efficiency of these systems, which could improve their operational capacity and power efficiency.

### SUMMARY OF THE DESCRIPTION

In an aspect, the present disclosure provides a fluid flow augmenting device for a fluid circulation system. The fluid flow augmenting device includes an annular body extending along a longitudinal axis and defining an internal volume of the fluid flow augmenting device. The annular body includes a fluid inlet on one longitudinal end and a fluid outlet on the other longitudinal end along the longitudinal axis. Further, the annular body includes a first fluid directing structure and a second fluid directing structure. The first fluid directing structure is adapted to receive a first fluid flow with a first fluid flow rate from a fluid source via the fluid inlet and direct the received first fluid flow into the internal volume of the fluid flow augmenting device. The second fluid directing structure is adapted to induce a second fluid flow with a second fluid flow rate from around the fluid flow augmenting device. The second fluid flow combines with the first fluid flow to generate an augmented fluid flow having an augmented fluid flow rate to be exhausted via the fluid outlet. The augmented fluid flow rate is greater than each of the first and second fluid flow rates.

In another aspect, the present disclosure provides a fluid circulation system. The fluid circulation system includes a heat transfer system, a fan assembly, an exhaust assembly, and a fluid flow augmenting device. The fluid flow augmenting device is fluidly connected to the fan assembly and the exhaust assembly and is adapted to augment a fluid flow through the heat transfer system. The fluid flow augmenting device includes an annular body extending along a longitudinal axis and defining an internal volume of the fluid flow augmenting device. The annular body includes a fluid inlet on one longitudinal end and a fluid outlet on the other longitudinal end along the longitudinal axis. Further, the annular body includes a first fluid directing structure and a second fluid directing structure. The first fluid directing structure receives a first fluid flow with a first fluid flow rate from the fan assembly via the fluid inlet and direct the received first fluid flow into the internal volume of the fluid flow augmenting device. The second fluid directing structure is adapted to induce a second fluid flow with a second fluid flow rate from around the fluid flow augmenting device. The second fluid flow combines with the first fluid flow to generate an augmented fluid flow having an augmented fluid flow rate to impinge on the heat transfer system and be directed to the exhaust assembly via the fluid outlet. The augmented fluid flow rate is greater than each of the first and second fluid flow rates.

### BRIEF DESCRIPTION OF THE DRAWINGS

Aspect of the description are provided below with reference to the appended drawings wherein:

FIG. 1 illustrates a fluid circulation system according to one aspect of the description.

FIGS. 2 and 3 illustrate a side elevation view of an outdoor unit of the fluid circulation system, in accordance with an aspect of the description.

FIG. 4 illustrates a side elevation view of a condenser assembly of the outdoor unit and one or more components internal to the condenser, in accordance with an aspect of the description.

FIGS. 5 and 6 illustrate perspective views of a fluid flow augmenting device, in accordance with an aspect of the description.

FIG. 7 illustrates a side elevation view of a fluid flow augmenting device, in accordance with an aspect of the description.

FIG. 8 illustrates a perspective view of internal partitions for use in the fluid flow augmenting device, in accordance with an aspect of the description.

FIG. 9 illustrates a top view of the fluid flow augmenting device, in accordance with another aspect of the description.

FIG. 10 illustrates a top view of the outdoor unit and components internal to a condenser assembly having the fluid flow augmenting device, in accordance with an aspect of the description.

FIG. 11 illustrates a side elevation view of a radiator and horizontal condenser system having a fluid flow augmenting device, according to another aspect of the present description.

FIG. 12 illustrates a side elevation view of a dry air-cooled radiator system having a fluid flow augmenting device, in accordance with another aspect of the description.

FIG. 13 illustrates a side elevation view of a system having a fluid flow augmenting device, in accordance with another aspect of the description.

FIG. 14 illustrates a side elevation view of a fluid flow augmenting device, in accordance with another aspect of the description.

FIG. 15 illustrates a side elevation view of a system having a fluid flow augmenting device, in accordance with another aspect of the description.

FIG. 16 illustrates a side elevation view of a system having a fluid flow augmenting device, in accordance with another aspect of the description.

FIG. 17 illustrates a top view of the system of FIG. 16.

FIG. 18 illustrates an outdoor unit with a fluid flow augmenting device, in accordance with another aspect of the description.

FIG. 19 illustrates a fluid flow augmenting device, in accordance with another aspect of the description.

FIG. 20 illustrates a side elevation view of a cooling tower having fluid a flow augmenting device, in accordance with aspects of the description.

FIG. 21 illustrates a side elevation view of a cooling tower having fluid flow augmenting device, in accordance with another aspect of the description.

FIG. 22 illustrates a side elevation view of a cooling tower having fluid flow augmenting device, in accordance with another aspect of the description.

FIG. 23 illustrates a fluid circulation system, in accordance with another aspect of the description.

FIG. 24 illustrates a top view of an outdoor unit of the fluid circulation system of FIG. 23.

FIG. 25 illustrates a front view of the outdoor unit of the fluid circulation system of FIG. 23;

FIG. 26 illustrates a top view of an outdoor unit of a fluid circulation system, in accordance with another aspect of the description.

FIG. 27 illustrates a front view of the outdoor unit of FIG. 26.

FIG. 28 illustrates a top view of an outdoor unit of a fluid circulation system, in accordance with another aspect of the description.

FIG. 29 illustrates a front view of the outdoor unit of FIG. 28.

FIG. 30 illustrates a front elevation view of a fluid flow augmenting device implemented with turning vanes, in accordance with another aspect of the description.

FIG. 31 illustrates a side elevation view of the example fluid flow augmenting device of FIG. 30.

FIG. 32 illustrates a top view of a fluid flow augmenting device implemented with turning vanes, in accordance with another aspect of the description.

FIG. 33 illustrates a side view of a fluid flow augmenting device with a second fan, in accordance with another aspect of the description.

### DETAILED DESCRIPTION

The present disclosure provides a fluid flow augmenting device that increases the volume of fluid that flows through a fluid circulation system without any equivalent increase in energy required to power the system and/or reduces the energy usage while retaining the fluid flow using existing configuration of the system.

In the following description, it is to be understood that the terms “vertical”, “longitudinal”, “lateral”, “horizontal”, “height”, “width”, “thickness”, “top”, “bottom”, “front”, “back”, and the like, will be used. These terms are meant to describe the orientation of the components of the present disclosure when positioned in a fluid circulation system and are not intended to limit the scope of the subject matter in any way. For example, the term “vertical” is used herein to refer to the “Y”, or longitudinal axis denoting a “height” of the assembly. It will be appreciated that the longitudinal axis may be referred to generally as “vertical” in the context where the assembly is positioned upright. The term “lateral” or “horizontal” is used herein to refer to the x-z plane containing the “X” axis denoting a “width” and the “Z” axis denoting a “thickness” of the assembly. Additionally, the terms “top” and “bottom” refer to the longitudinal top portion and the longitudinal bottom portion of a component disposed along the longitudinal axis when the assembly is in the upright position. As such, these terms will be understood to mean relative orientations and positional relationships of the components in the assembly and are not intended to mean orientations and positional relationships with respect to an external reference point.

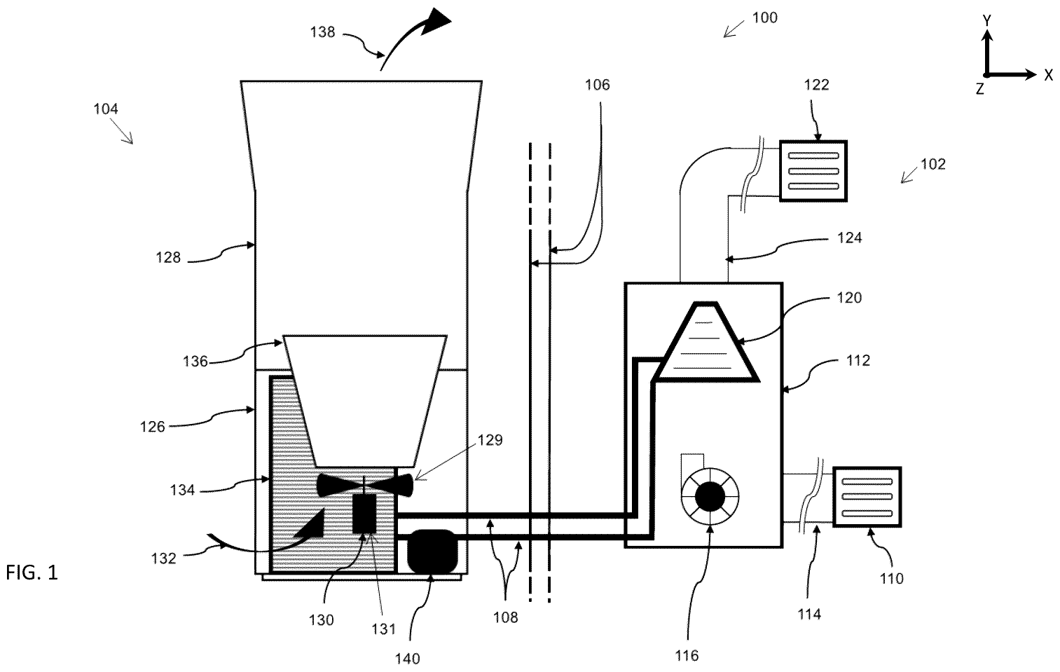

FIG. 1 illustrates a fluid circulation system 100 according to aspect of the present disclosure. In one example, as shown in FIG. 1, the fluid circulation system 100 may be embodied as an indoor Heating, Ventilation, and Air Conditioning (HVAC) system (hereinafter referred to as the system 100) that may be implemented in an industrial or a residential building to condition air flowing through the HVAC system. A fluid, such as air, in this example, may be directed through various chambers, sections, or plenums of the system 100, such as, but not limited to, a condensing section, an evaporating section, a heating section, a discharge section, or any combination thereof. Circulation of the air through these sections may enable the system 100 to condition the air in a variety of manners, including but not limited to cooling, heating, dehumidification, and so forth. In the illustrated embodiment, the system 100 is configured to condition a supply air stream, such as environmental air and/or a return airflow from a building and circulate the conditioned air back to the building. Although the present disclosure is illustrated and described for a HVAC system, it may be appreciated that in various applications, the system 100 may be implemented as any other type of fluid circulation system, such as, but not limited to, a cooling tower, a vehicular HVAC, a commercial refrigeration system, an industrial freezer, coolers, and so on.

The system 100 may, in some examples, be part of a split system, such as that shown in FIG. 1, which includes an indoor unit 102 and an outdoor unit 104 fluidly connected to the indoor unit 102 via one or more refrigerant lines 108. However, in some other examples, the system 100 may be implemented as a single assembly unit such as for use in residential, commercial, or industrial applications, that may be mounted, for example, on a roof of the building. The indoor unit 102 may be positioned, for example, inside the building (e.g., as shown on the right side of a building wall 106 in FIG. 1) and the outdoor unit 104 may be positioned outside the building, for example, on a roof or adjacent to the building (e.g., as shown on the left side of the building wall 106). The refrigerant lines 108 may be configured to transfer a refrigerant between the indoor unit 102 and the outdoor unit 104, such as provide the refrigerant in liquid form in one direction and return the vaporized refrigerant in an opposite direction.

The indoor unit 102 may include a return air vent 110 fluidly connected to an air handler unit 112 via a return air conduit 114. Return air may enter the return air vent 110 and flow into the air handler unit 112 via the return air conduit 114. The air handler unit 112 may be driven by a blower fan and motor 116 to direct the air through and across a heat exchanger unit 120 that may be configured to heat up and/or cool down the air, as desired, and distribute the air out of the supply air vent 122 via one or more supply conduit 124 to environments within the building, such as rooms, apartments, or offices, to maintain the environments at a designated temperature. A control device, such as a thermostat (not shown), may be used to designate the temperature of the conditioned air. The control device also may be used to control the flow of air through and from the air handler unit 112 and to diagnose mechanical or electrical problems with the air handler unit 112. Other devices may also be included in the system, such as control valves that regulate the flow of refrigerant and pressure and/or temperature transducers or switches that sense the temperatures and pressures of the refrigerant, the air, and so forth. Moreover, the control device may also communicate with computer systems that may be integrated with or are separate from other building control or monitoring systems, and even systems that are remote from the building.

The outdoor unit 104 may include a condenser assembly 126 (e.g., radiator) and an exhaust assembly 128 positioned, for example, beside the building wall 106. The condenser assembly 126 may be fluidly connected with the air handler unit 112 of the indoor unit 102 via the refrigeration lines 108. In some embodiments, such as that shown in FIG. 1, the outdoor unit 104 may have the condenser assembly 126 and the exhaust assembly 128 arranged in a stacked or a vertical discharge configuration. However, in some other embodiments, the condenser assembly 126 and the exhaust assembly 128 may be arranged in a side-by-side or horizontal discharge configuration or any other configuration to achieve similar results.

The condenser assembly 126 may include a fan assembly 130 configured to draw in cool ambient air (as shown by arrow 132) through one or more condenser coils 134. For example, when the system 100 is turned on in a cooling mode (such as that illustrated in FIG. 1), hot refrigerant flows through the condenser coils 134 (i.e., the heat transfer medium) and the fan assembly 130 rotates to draw in the ambient air surrounding the condenser assembly 126 across the lower condenser coils 134 (which cools the refrigerant through heat transfer), and into the lower section of the condenser assembly 126.

As illustrated, the fan assembly 130 may include one or more fans 129 and one or more motors 131 (only one shown in FIG. 1) operatively coupled to drive the fan(s) 129. In some implementations, each of the one or more fans 129 may be identical to one another while in some other implementations, the one or more fans 129 may have different shapes and sizes. Fan 129 may include one or more fan blades, an angle of which rotates the air and directs it into the condenser assembly 126. Examples of the fan 129 may include, but not limited to, a low-pressure axial fan, a propeller fan, a tube axial fan, a vane axial fan, a mixed-flow impeller fan, a centrifugal fan, and so on. The fan selection may depend on one or more variables associated with the application, such as flow requirements, pressure, power, or geometry of the application. In one example, the fan assembly 130 may include a motor shaft and the fan 129 may be mounted on the motor shaft to be driven by the motor 131. In another example, the fan assembly 130 may include a fan shaft and a motor shaft, both having sheaves, and a belt in contact with both the sheaves configured to transmit torque from the motor 131 to the fan 129. In a yet another example, the fan assembly 130 may include the motor 131, a gearbox, and a coupling between them configured to transmit torque to the fan 129.

The outdoor unit 104 may further include a compressor 140 configured to circulate the refrigerant between the condenser coil(s) 134 and the heat exchanger unit 120 of the indoor unit 102. For example, the compressor 140 may be configured to decrease the volume of the refrigerant vapor, thereby increasing the temperature and pressure of the vapor which may then be directed to the condenser coils 134. The compressor 140 may be embodied as any suitable compressor such as a screw compressor, reciprocating compressor, rotary compressor, swing link compressor, scroll compressor, turbine compressor, or any other type of compressor known in the art.

In an embodiment of the present disclosure, the outdoor unit 104 further includes a fluid flow augmenting device 136 positioned in fluid communication with the fan assembly 130 and the exhaust assembly 128 and configured to augment the fluid flow (in this example, the airflow from the fan assembly 130) through and around the heat exchanger unit (i.e., the condenser coils 134 in this example) to improve its heat exchange efficiency or the cooling capacity without significant additional power consumption. The fluid flow augmenting device 136 may be positioned downstream and/or upstream of the fan 129. In some embodiments, such as that shown in FIGS. 1 to 3, the fluid flow augmenting device 136 may be positioned vertically in a stacked configuration within the outdoor unit 104 implemented as a vertical or top discharge assembly. However, it may be appreciated that the positioning and orientation of the fluid flow augmenting device 136 may be varied according to the configuration of the outdoor unit and/or the end application in which the fluid flow augmenting device 136 is employed. For example, in an outdoor unit implemented as a side or horizontal discharge assembly, the fluid flow augmenting device may be positioned horizontally in front of the fan assembly instead of being stacked on the fan assembly. Further, although only one fluid flow augmenting device 136 is shown and described herein, it may be appreciated that the fluid circulation system 100 and/or the outdoor unit 104 may include multiple fluid flow augmenting devices positioned, for example, in parallel or in series with one another and wherein each of the fluid flow augmenting devices may operate in a similar manner and/or cooperate with one another to further augment the fluid flow and improve the heat exchange efficiency.

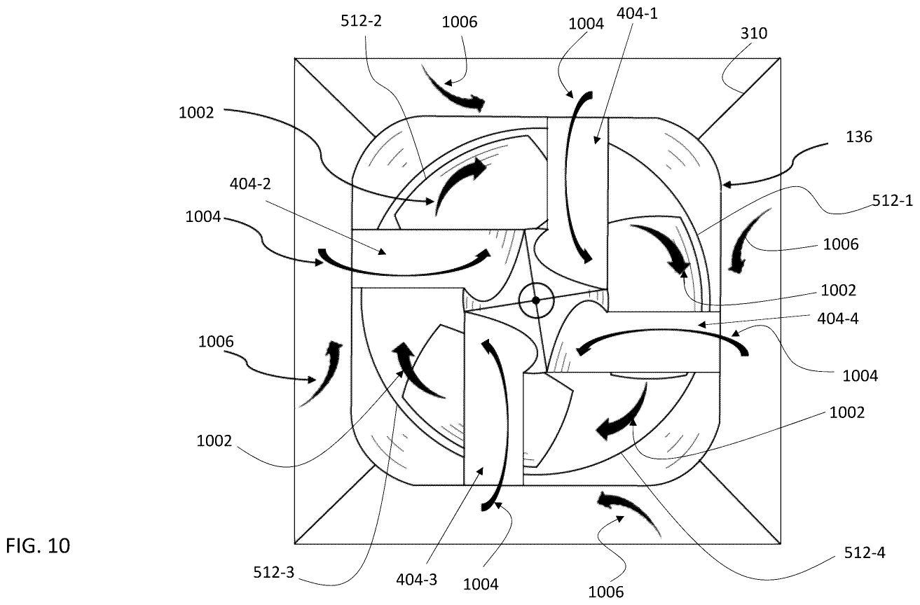

In some examples, the condenser coils 134 may be disposed downstream of the fluid flow augmenting device 136. The air within the condenser assembly 126 may be directed by the fan assembly 130 and the fluid flow augmenting device 136 up and out through the exhaust assembly 128 (as shown by arrow 138). To this end, the fluid flow augmenting device may include one or more fluid directing structures, such as orifices, conduits, or ducts arranged to induce and entrain additional ambient airflow and supplement the airflow (referred to as a ‘first airflow’, e.g., shown by a set of arrows 1002 in FIG. 10) and airflow rate (referred to as ‘first airflow rate’) from the fan assembly 130 to generate an augmented or ‘combined airflow’ having a ‘combined airflow rate’ exiting the fluid flow augmenting device 130. The combined airflow rate is greater than the first airflow rate from the fan assembly 130 and the combined airflow impinges on the heat exchanger unit (i.e., the condenser coils 134 in this example) thereby cooling the refrigerant through heat transfer. In some examples, the combined airflow rate may be at least 30% greater than the first airflow rate, while in some other examples, the combined airflow rate may be at least 50% greater than the first airflow rate.

The fluid flow augmenting device 136 (hereinafter interchangeably referred to as the device 136) of the present disclosure results in improved overall cooling rates for a given footprint and power consumption of a fluid circulating system, such as the system 100 in the present example. The device 136 may deliver, for example, a 5% greater fluid flow for a given energy consumption or a 10% lower energy consumption compared to the fluid flow of a same system without such a device. In some examples, without an ambient crosswind, the system 100 having the fluid flow augmenting device 136 may have an increased fluid flow in a range of about 5% to 60% drawn through the condenser assembly 126 or other air handling system with less than 1% increase in power consumption. In some other examples, when operating with an ambient crosswind in a range of about 4 meters per second (m/s) to 8 m/s, the system 100 having the fluid flow augmenting device 136 may have an increased fluid flow in a range of about 40% to 60% drawn through the condenser assembly 126 or other air handling system with less than 1% increase in power consumption. For instance, fluid testing with pilot systems and fluid simulations has demonstrated fluid flow rate increases of over 50% compared to nominal airflows without the device 136.

Although the present disclosure is provided for the fluid flow augmenting device 136 being implemented as part of the HVAC system 100, it may be contemplated that the device 136 may also be implemented in heat pumps operated in heating or cooling mode, such as to increase airflow across the external heat exchanger, HVAC exchangers (V-shaped, flat, or other forms of heat exchangers and condensers), exhausts, computers, air conditioning cooling devices, commercial refrigeration systems, industrial freezers, chillers, vehicle HVACs or air conditioning systems to cool vehicles, or any other heat rejection systems to improve their fluid flow handling efficiency and capacity in a similar manner as described herein the present disclosure. Moreover, the present description provides uses of the fluid flow augmenting device 136. It will, however, be appreciated by persons skilled in the art that the fluid flow augmenting device 136 may be adapted for use with other devices where fans are incorporated, in order to increase the flowrate of the fluid exiting the fan.

In one aspect, such as that illustrated herein, the fluid flow augmenting device 136 may be disposed downstream of the fan 129 to augment or multiply the airflow and improve the heat exchange within the condenser coils 134 (containing coolant of an elevated temperature) disposed downstream of the device 136. In some other examples, the fan 129 may alternatively be positioned downstream of the device 136 while in some other examples, the outdoor unit 104 may include more than one fan, for example, one being positioned upstream of the device 136 and another one positioned downstream of the device 136. In some yet other examples, the outdoor unit 104 may include a first fan positioned upstream of the device 136 and a second fan positioned inside the device 136 itself.

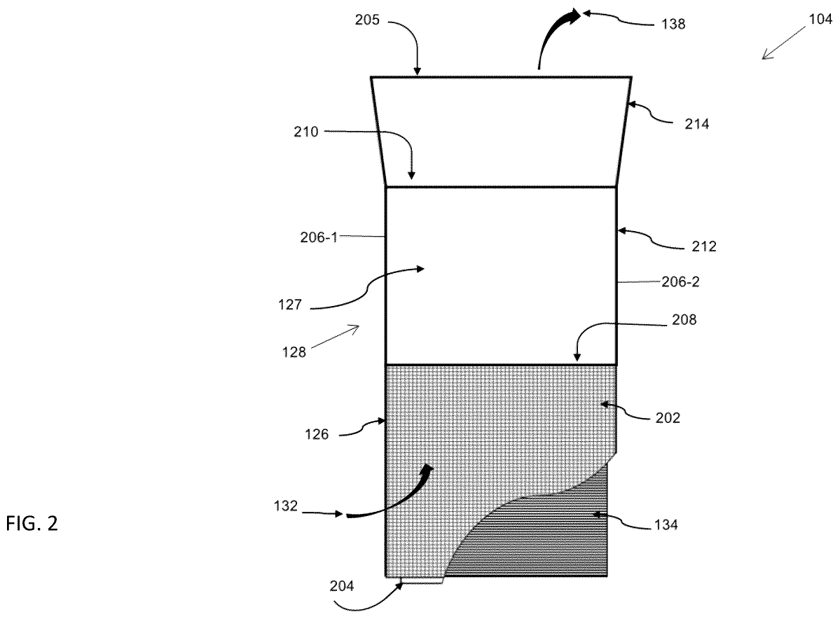

FIG. 2 illustrates a side elevation view of an outdoor unit 104, according to the various embodiments of the present disclosure. As shown, an outer condenser housing 202 of the condenser assembly 126 may be supported on a condenser base 204 and the exhaust assembly 128 may be supported or mounted on top of the condenser housing 202. In some examples, the condenser housing 202 may be a stamped sheet metal housing with perforations to allow airflow and that may be configured to protect fins (such as aluminum fins) on the outside of the condenser coils 134. Further, the condenser coils 134 may include a seal (e.g., a foam seal) at the top to force air through the coils 134 instead of bypassing over the top.

The cool ambient air 132 may be drawn into the condenser 126 and the warmed air may be exhausted out through a stack outlet 205 of the exhaust assembly 128 (as shown by the arrow 138). In one embodiment, the exhaust assembly 128 may include an exhaust stack 127 that allows the exhaust air to be released into the environment via the outlet 205. The exhaust stack 127 may, in some examples, be implemented as a conventional (traditional) stack and/or a velocity reducing (recovery) stack, in which the airflow velocity may be diminished, and the horsepower requirement on the fan 129 may be reduced. However, in some alternative embodiments, the exhaust stack 127 may be formed into a nozzle shape or simply an orifice, positioned downstream of the fluid flow augmenting device 136 to exhaust the airflow. Additionally, material to reduce acoustic emissions may be applied internally or externally to the exhaust stack 127 and or other system components to reduce the noise levels emitted. Furthermore, insulation may also be applied to the components for increased thermal efficiency. It may be appreciated that the material used for insulation and noise reduction may be same in some implementations. It may also be appreciated that the exhaust assembly 128 may include additional or fewer components in various implementations, to achieve similar functionalities.

In the illustrated example, the exhaust stack 127 may include outer walls 206-1, 206-2 that may extend from a condenser-to-stack transition 208 upwardly and parallel to one another to a stack transition line 210 to define a first stack section 212, for example, a stack center section and may further taper out from the stack transition line 210 towards the stack outlet 205 to define a second stack section 214. The second stack section 214 may define a trapezoidal cross-section configured to facilitate a reduction in velocity of the exhausted air and hence is also referred to as the velocity reducing section of the exhaust stack 127. In one example, the second stack section 214 may define a relief angle of 7 degrees however, other configurations may also be contemplated to achieve similar results. The condenser-to-exhaust stack transition 208 may be configured to accommodate a potential variation in the layout between the condenser housing 202 and the exhaust stack 127. In some examples, the exhaust stack 127 may have a form factor (such as square shape) aligned with that of the condenser housing 202 to facilitate mounting the exhaust stack 127 on top of the condenser housing 202, while in some other examples, they may be different (such as the exhaust stack 127 may be rounded or have a square to round transition for mounting to the condenser housing 202) to further enhance the fluid flow augmentation and benefit a vortex generation of the internal airflow. Additionally, although, the stack transition line 210 and the condenser-to-stack transition 208 are shown to be straight, it may be appreciated that either one or both of them may be curved for improved aerodynamics. Further, although the exhaust stack 127 is shown and described to have the velocity reducing section 214, it may be contemplated that the exhaust stack 127 without such section may also be implemented in some alternative implementations. Moreover, the design and profile of the fluid flow augment device 136 may also be configured to increase or decrease an amount of vortex generation, to match the desired application and/or to produce laminar airflow and non-vortex airflow through the system 100.

Although only one exhaust assembly 128 is shown and described, it may be appreciated that in larger installations, a plurality of exhaust assemblies may be used in combination to process large volumes of airflow. Multiple fluid flow augmenting devices and exhaust assemblies may be installed on a single cooling system. Additionally, in some embodiments, vortex generators (not shown) may be installed within the exhaust stack 127 and may be attached, for example, to the fluid flow augmenting device 136 internally or externally, or the surrounding structure in order to increase turbulence to induce or entrain a greater airflow through the fluid flow augmenting device 136 or the system 100.

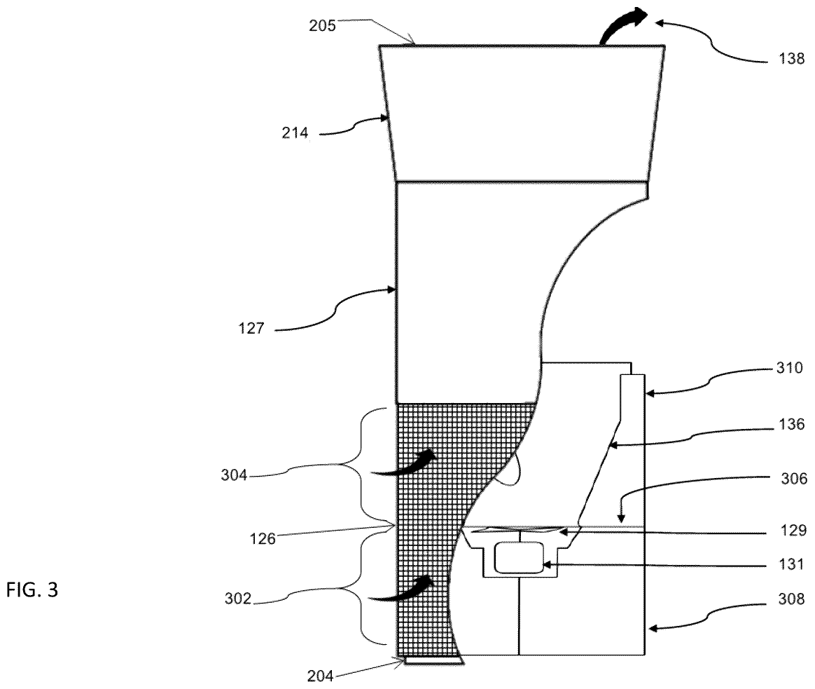

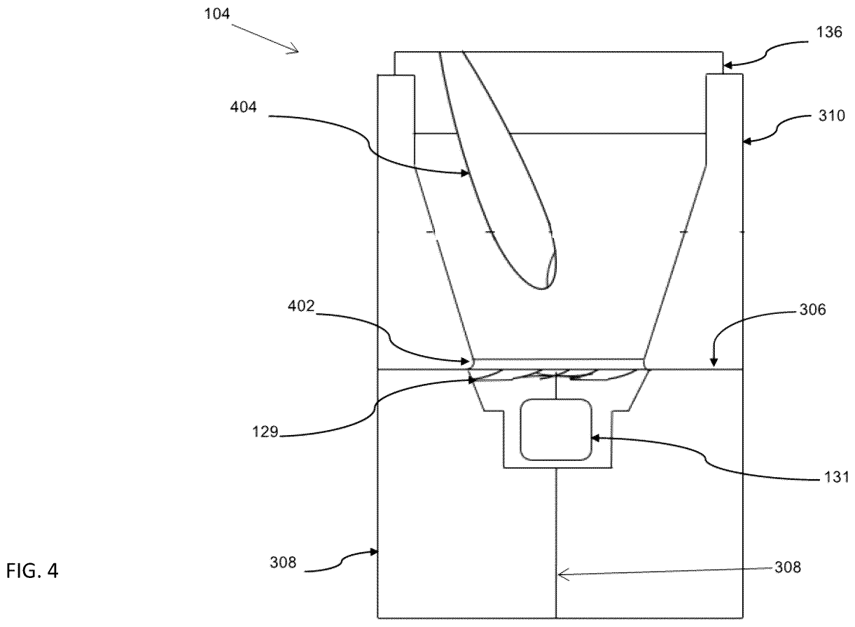

Referring now to FIGS. 3 and 4, the condenser assembly 126 may include a first or lower condenser section 302 having a lower section of condenser coils 134 and a second or upper condenser section 304 having an upper section of the condenser coils 134 therein. The fan 129 may be configured to draw in cool ambient air through the lower condenser section 302, while the fluid flow augmenting device 136 draws in additional air (such as ambient air via one or more air ducts 404) through the upper condenser section 304 to direct a heated air that is expelled (shown as 138) through the exhaust stack outlet 205 via the velocity-reducing section 214.

The condenser assembly 126 may include a support member 306, for example, to create a partition between the lower condenser section 302 and the upper condenser section 304. In the illustrated example, the support member 306 is implemented as a laterally disposed table (hereinafter referred to as the table 306) positioned around and configured to mount the fan 129 thereto, while the motor 131 may be mounted either above or below the fan 129. The table 306 may define a tabletop that supports the fan 129 and on which the fluid flow augmenting device 136 may be positioned. The table 306 may be further configured to partition the airflow upstream of the fan 129 from the airflow adjacent the fan 129. The table 306 may further include or support a bell mouth radius 402 (as shown in FIG. 4) that may be positioned in between and transition from the table 306 up to the fluid flow augmenting device 136 to guide the airflow from the fan 129 into the fluid flow augmenting device 136. In some examples, this bell mouth radius 402 may be formed as an integral part of either the device 136 or the table 306, while in some other examples, it may be a separate structure positioned between the two. The table 306 may also include or support a horizontal or lateral partition (not shown) positioned at and extending between one or more edges of the table 306 and the condenser housing 202. The horizontal partition may be configured to prevent recycling around the edges of the table 306, which would allow the fan 129 to draw in the ambient air. In some examples, the table 306 may be positioned in accordance with a desired elevation of the fan 129, which in the present example, is shown to be about 50% of the condenser coil 134 height from the condenser base 204.

Further, four walls may be vertically disposed to extend downwardly from the table 306 along a longitudinal axis of the outdoor unit 104 and towards the condenser base 204 to act as table legs 308. The table legs 308 may be configured to act as partitions in the lower condenser section 302 and support the table 306 and the fan and motor assembly 130 to also inhibit crosswind. In some examples, the table legs 308 may be laid out corner to corner, each being spaced 90 degrees around a center axis (not shown) of the assembly supporting the table 306 and may also be configured to assist in guiding the air drawn in through the fan 129. For example, the table legs 308 may act as straightening vanes to efficiently direct air into an inlet of the device 136, and therefore, turning these vanes may also be used to produce appropriate changes in airflow direction through the fluid flow augmenting device 136. Further, as shown, one or more outer partition walls 310 may be positioned atop the table 306 and may be disposed between the fluid flow augmenting device 136 and the condenser assembly 126, thereby creating a box-like structure, to create a partition from an outer corner of the fluid flow augmenting device 136 to an inside corner of a housing of the fan and motor assembly 130 and prevent crosswind from blowing directly through the condenser 126. For example, the outer partition walls 310 may capture crosswind and redirect the crosswind flow to align with the exhaust of the fluid flow augmenting device 136 around the perimeter, as well as up through the center of the device 136. In an embodiment of the present disclosure, the fluid flow augmenting device 136 may be supported on the table 306 and the table legs 308, and an annular space may be defined between the device 136 and the upper condenser section 304 surrounding the device 136. The annular space may be configured to increase the flow rate of the entrained airflow of the additional air drawn in by the device 136 into the annular space.

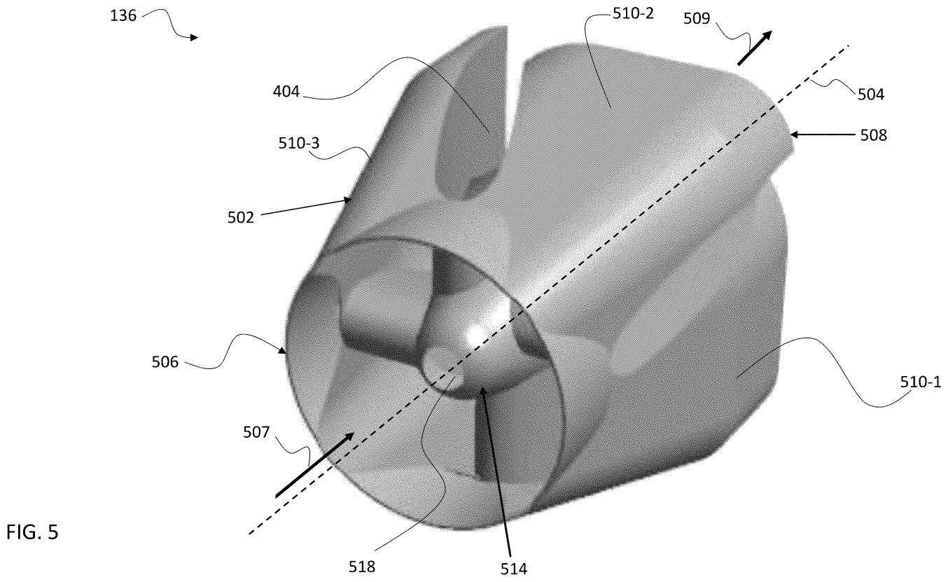

Referring now to FIGS. 5 through 9, the structural and operational details of the fluid flow augmenting device 136 will be described in greater detail. The fluid flow augmenting device 136 includes an annular body 502 (e.g., a generally cylindrical body as shown) extending along a longitudinal axis 504 of the device 136. It will be appreciated that when positioned in a vertical discharge assembly, the longitudinal axis 504 of the fluid flow augmenting device 136 may be parallel to the longitudinal or Y-axis of the outdoor unit 104, whereas, when positioned in a side discharge assembly, the longitudinal axis 504 may be parallel to the Z-axis of the outdoor unit 104. However, it may be contemplated that these orientations of the fluid flow augmenting device 136 are described with respect to certain aspects and that they may be varied to achieve similar results. In various embodiments of the present disclosure, the fluid flow augmenting device 136 may have a form factor that includes one or more of the following profiles: round, square, elliptical, triangular, lobed, squircle, or the like, when viewed from upstream. The annular body 502 defines a first longitudinal end 506 and a second longitudinal end 508 opposite to the first longitudinal end 506 along the axis 504. In one implementation, the first longitudinal end 506 may define an air inlet 507 for the device 136 that may be positioned, for example, to contact and engage with the table 306, whereas the second longitudinal end 508 may define an air outlet 509 for the device 136 and may be positioned to contact and engage with the exhaust stack 127. As illustrated in FIG. 5, the fluid flow augmenting device 136 may have a roughly conical shape with the second longitudinal end 508 possessing a larger opening (i.e., at the air outlet 509) and may taper in an opposite direction to that of the airflow to have a relatively smaller opening at the first longitudinal end 506 (i.e., the air inlet 507).

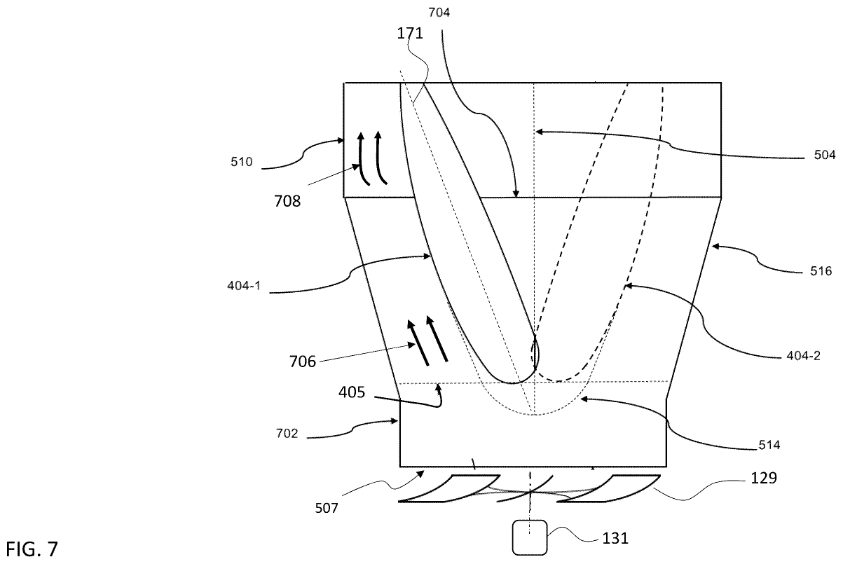

The air inlet 507 may be a bell mouth ring inlet that may be configured to be centered with the fan 129. The fan air from the fan 129 may flow into the fluid flow augmenting device 136 via an inlet edge of the air inlet 507 around an inner cone 514 and the ducts 404 of the device 136. The air outlet 509 may also define an exhaust edge that may have an increased geometric perimeter relative to the air inlet 507 and may be implemented as one or more of mixing lobes, scalloped edges, elliptical pattern, or partial ellipses, one or more chevrons that may include a scalloped pattern, or the like. In some embodiments, the air inlet 507 and the outlet 509 may include rounded edges to facilitate efficient airflow therethrough. The fan air entering from the fan 129 (hereinafter the ‘first airflow’, e.g., as shown by set of arrows 1002 in FIG. 10) having a first airflow rate may be configured to travel in a specified direction (shown in FIG. 7 by arrows 706, 708), which in the illustrated example is defined from the fan 129 up to the stack outlet 205 via the fluid flow augmenting device 136. As will be appreciated, the blades of the fan 129 may be angled, that rotates the air and directs it into the condenser assembly 126 through the fluid flow augmenting device 136 via the inlet 507.

The device 136 further includes one or more external walls 510 that may extend between the first end 506 and the second end 508 and configured to define a periphery and an internal volume of the device 136. In some examples, the external walls 510 may have a round, square, elliptical, triangular, lobed, or squircle configuration when viewed from above. The internal volume of the device 136 may be divided into two sections, namely, a first or the inner cone 514 and a second or outer cone 516 fluidly connected to the inner cone 514. Each of the inner cone 514 and the outer cone 516 are fluidly connected to the air inlet 507 and the air outlet 509 and may be configured to generate their respective internal airflows within the internal volume of the fluid flow augmenting device 136, such that the airflow from each of these sections supplements the combined airflow prior to exiting the outlet 509. The outer cone 516 may be supported by the air inlet 507. In one example, the inner cone 514 may further include an aperture or opening 518 located on a bottom end (i.e., the end facing or proximal to the fan 129) to energize the airflow up through the inner cone 514. The aperture or opening 518 may be further enlarged for a greater percentage of airflow. In some other embodiments, the aperture 518 may include a surface forming a tube, cone, or any other shape that extends towards the outlet edges and beyond. Alternatively, the bottom of the inner cone 514 may remain closed.

Referring to FIG. 7, in an embodiment, the fan air inlet 507 may transition to the outer cone 516 to define a fan transition area 702 of the fluid flow augmenting device 136. As illustrated, the outer cone 516 may be angled away from the center axis 504 up to a transition point 704, where the external walls 510 may transition toward the center axis 504 of the device 136. One or more openings (not shown) may be created in the fan transition area 702 to create, for example, a coanda surface for receiving high-velocity fan air. It may be appreciated that the angles and lines of intersection of the outer cone 516, the transition point 704, and other surfaces may be smoothed out or rounded for increased aerodynamics and airflow efficiency, as opposed to sharp angles in the design which may impede flow. The fan 129 rotates the air and directs it into the inlet 507 at an angle (as shown by arrows 706) which then interacts with the ducts 404 to be redirected and aligned with the walls 510 (as shown by arrows 708).

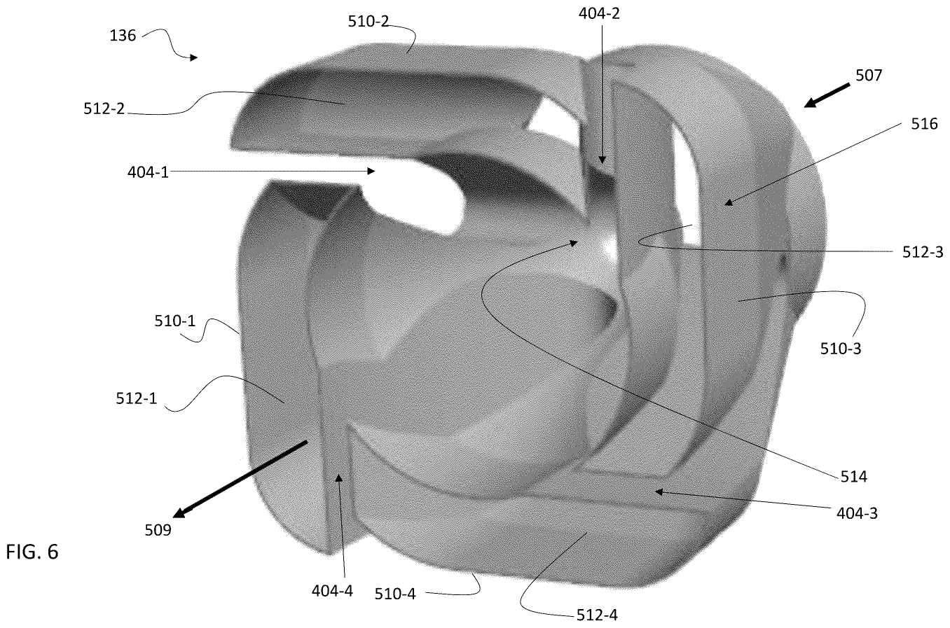

Referring back to FIGS. 5 and 6, in an embodiment, the external walls 510 may further define one or more fluid directing structures, such as air channels or conduits 512 (hereinafter referred to as the conduits 512) fluidly connected to receive the air driven by the fan 129 (i.e., the first airflow 1002) and guide the air up through the perimeter of the device 136 and into the exhaust assembly 128. In some examples, the conduits 512 may be positioned symmetrically about the periphery of the device 136 and may each extend longitudinally along the axis 504 to define, for example, a hollow cross-sectional profile having one or more contact surfaces that guide the air from the fan 129 to vertically funnel into the conduit 512, which may be expelled from the device 136, above the condenser assembly 126 and through the exhaust stack 127. The external walls 510 may facilitate aligning the first airflow from the fan 129 with the exhaust stack 127. In some examples, the conduits 512 may be implemented as airfoils having an inlet surface and an outlet surface with a number of rounded edges defined on the inlet and the outlet surfaces to allow the fan air to enter directly into the internal volume of the fluid flow augmenting device 136, where it can be added to a second airflow, (e.g., the additional ambient airflow) to increase the output airflow of the device 136 into the exhaust assembly 128. Although only one fan 129 is shown and described, it may be appreciated that in case there are multiple fans included, they may all contribute to the inlet airflow in a similar manner. Additionally, in case of having multiple fluid flow augmenting devices, each fan May contribute to the inlets of the fluid flow augmenting devices. In such implementations, the fluid flow augmenting devices may be laid out in a pattern around the airflow from the fan(s) 129, to provide an efficient inlet for the fan air. Moreover, in some implementations where multiple fluid flow augmenting devices 136 are connected in series, the ducts 404 may be formed so as to extend beyond the respective fluid flow augmenting device to induce of the second airflow.

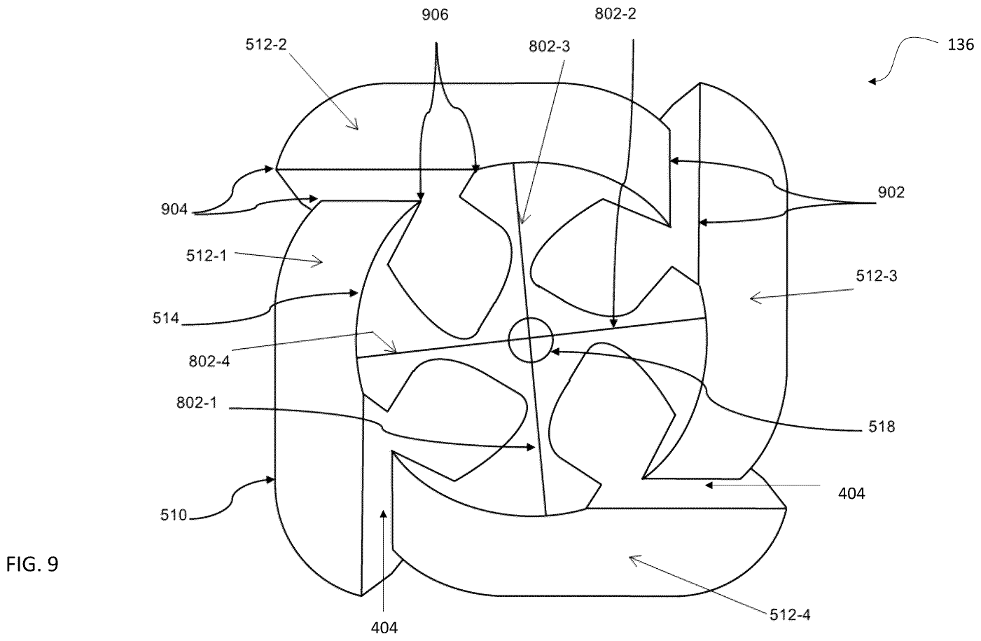

Further, in an embodiment of the present disclosure, additional fluid directing structures, such as one or more orifices or ducts (e.g., the ducts 404) may be provided in the external wall 510 to allow the additional ambient air to enter into the internal volume (or the center) of the device 136 and supplement the airflow from the fan 129 via the air inlet 507, thereby forming the combined airflow with the corresponding combined airflow rate that exits the outlet 509 of the device 136. To this end, in the illustrated example, the conduits 512 are configured to be spaced and disposed at an angle of, for example, about 90 degrees with respect to the adjacent ones to define one or more orifices including the corresponding air ducts 404. The ducts 404 may also be positioned and spaced apart around the fluid flow augmenting device 136. The air ducts 404 may be configured to fluidly connect the respective conduits to the air outside the fluid flow augmenting device 136. As illustrated, the air ducts 404 may also possess suitable aerodynamic profile to facilitate drawing in of additional air from around and outside the perimeter of the device 136. For example, as shown in FIG. 9, the conduits 512 may include respective external surfaces 902 that may define the profile of the ducts 404, and these external surfaces 902 (as well as one or more surfaces of the inner cone 514, in some embodiments) may incorporate one or more patterns, such as, but not limited to, a chevron, scalloping, or elliptical, to facilitate an increased airflow into the fluid flow augmenting device 136. Further, the ducts 404 may be configured to meet the external walls 510 of the corresponding conduits 512 at and to define one or more outer ducting corners 904 and meet the inner cone 514 at and to define respective inner ducting corners 906. The profiles of the ducts 404, the internal surfaces 902 of the conduits 512, and the corners 904, 906 may be designed to enhance the airflow. In some implementations, the ducts 404 may extend beyond the annular body 502, for example, to surround all or a portion of the air inlet or the fluid inlet 507 at the first end 506. In some other implementations, the ducts 404 may join one or more other ducts provided in the fluid flow augmenting device 136.

The ducts 404 may be fluidly disconnected from the air inlet 507 so as to induce the additional air from around the perimeter into the center of the device 136 (e.g., the inner cone 514) and cause it to be entrained with the first airflow (i.e., the fan airflow) to generate the combined airflow that may then be expelled through the exhaust assembly 128. This induced airflow (hereinafter referred to as the ‘second airflow’, e.g., shown by set of arrows 1004 in FIG. 10) may have a corresponding airflow rate (hereinafter referred to as the ‘second airflow rate’) which combines with the first airflow rate from the fan 129 to generate the combined airflow rate. Further, the ducts 404 may each define their respective airflows, and all of which supplement the first airflow to contribute to the combined airflow.

For example, in operation, high-velocity air from the fan 129 may be exhausted through the top of the fluid flow augmenting device 136, thereby creating vortices downstream of the conduits' 512 exhaust edges. These vortices create a low-pressure area in the center region (e.g., the inner cone 514) of the device 136, as air from the center is induced downstream into the surrounding high-velocity flow. This low pressure facilitates the second airflow to enter through the ducts 404 inside the device 136, as explained above. The first and second airflows may then combine through mixing, due to the vortices from the high-velocity air travelling in the conduits to generate the combined airflow.

In an embodiment, as shown in FIG. 7, the ducts 404 may have rounded edges and rounded closed ends, such as that shown towards a duct bottom end 405 and an axis 171 of symmetry that may be angled in relation to the longitudinal axis 504 of the fluid flow augmenting device 136 to allow the rotational or swirling flow of the air downstream of the fluid flow augmenting device 136. For example, the ducts 404 may be angled downstream with respect to the axis of the fluid flow augmenting device 136 by an angle in the range of about 10 degrees and 80 degrees. In some examples, the air ducts 404 may be situated at approximately equal angular distances from one another and situated at approximately equal linear geometric distance from the fan 129. In some alternative examples, the ducts 404 may not be placed at equal distances from one another, however, may be placed at approximately equal linear geometric distance from the fan 129. In some yet other examples, at least some of the ducts 404 may not be placed at equal distances from the fan 129. The ducts 404 may be in the form of an airfoil, a coanda surface, a venturi, an aspirating nozzle, an ejector, an injector, an eductor, or the like. As will be appreciated, the ducts 404 and other components of the described herein the present disclosure, may be oriented in a symmetrical, or asymmetrical arrangement to suit the application. For example, asymmetry may be beneficial for applications where the second airflow 1004 accesses the fluid flow augmenting device 136 from one direction. In other applications where the second airflow 1004 accesses the fluid flow augmenting device 136 from two opposite directions, the ducts 404 may bifurcate the fluid flow augmenting device 136.

In some additional embodiments, one or more orifices and/or passages (not shown) may be added to the inner cone 514 and/or the ducts 404, to allow the high-velocity air from the fan 129 to add to the induced second airflow and motivate the induced second airflow towards the downstream exhaust edge. These orifices and passages may also be used to assemble one or more fluid flow augmenting devices 136 in series or in parallel downstream of the first device 136. The orifices may be set out in a symmetrical or an asymmetrical layout, with varied lengths and angles from the center axis 504 of the device 136. Further, in some embodiments, the ducts 404 may be perpendicular to the center axis of the airflow or may be set at an angle of axis between 10 and 180 degrees to increase airflow efficiency.

Further, a ‘third airflow’ (shown by a set of arrows 1006 in FIG. 10) of air may be drawn in through the upper condenser section 304 around the perimeter of the device 136 and configured to be entrained with the first airflow 1002 from the fan 129 and the second airflow 1004 to further supplement the combined airflow outputted to the exhaust assembly 128. In one aspect, the third airflow and the corresponding third airflow rate may be configured to not pass through the internal volume or center of the fluid flow augmenting device 136 to supplement the combined airflow and the combined airflow rate. For example, the annular space defined between the device 136 and the upper condenser section 304 surrounding the device 136 may be configured to allow the third airflow to be flown into the combined airflow that is expelled from the exhaust assembly 128.

The fluid flow augmenting device 136 of the present disclosure may be configured to modify the first airflow 1002 to generate the combined airflow via one or more of a non-vortex turbulent motion, non-vortex laminar motion, or a vortex (as explained above). For example, depending on the end application, it may be beneficial to increase or decrease a laminar, turbulent, and vortex flows in different sections of the fluid circulation system for heat transfer and airflow efficiencies. Further, in some embodiments, the three airflows may combine downstream of the fluid flow augmenting device 136, while in some alternative or additional embodiments, the three airflows may combine within the internal volume of the fluid flow augmenting device 136. Further, the fluid flow augmenting device 136 may be designed to create either the second airflow and/or the third airflow in any desired ratio as they combine into the total flow of the system 100. In some additional or alternative implementations, the fluid flow augmenting device 136 may be designed to solely utilize the third airflow around the perimeter to be combined with the first airflow from the fan 129. Furthermore, in the case of employing multiple fluid flow augmenting devices, it may be appreciated that each device may create its respective combined airflow in a similar manner.

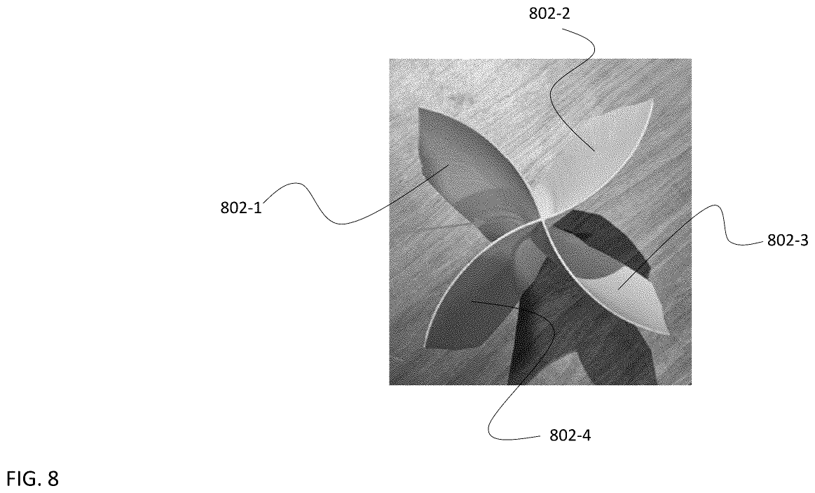

In an embodiment of the present disclosure, the fluid flow augmenting device 136 may also include one or more internal partitions 802 (shown in FIG. 8) positioned therein, for example, in the inner cone 514 to define corresponding internal compartments having respective internal volumes inside the device 136. Each of the internal compartments is configured to be fluidly connected with the air inlet 507 as well as the air outlet 509 of the fluid flow augmenting device 136. It will be appreciated that the number and configuration of the internal partitions 802 and the internal compartments as shown and described herein by way of example and that they may be varied to achieve similar results. In an embodiment, the internal partitions 802 may also include a suitable aerodynamic profile and may be angled suitably to complement and align with the profile and angling of the ducts 404. The internal partitions 802 may be configured to prevent crosswind from blowing through the center of the fluid flow augmenting device 136 and modify the direction of the airflow therein.

As explained previously, the application of the fluid flow augmenting device 136 in an HVAC system is one example of how the device may be used. It will be appreciated that such a device can be implemented in many applications, such as in heat pumps operated in heating or cooling mode, such as to increase airflow across the external heat exchanger, HVAC exchangers (V-shaped, flat, or other forms of heat exchangers and condensers), exhausts, computers, and air conditioning cooling devices, commercial refrigeration systems, industrial freezers, or vehicle air conditioning systems to cool vehicles, to improve their fluid flow handling efficiency and capacity, and thus improve their overall power consumption. Furthermore, the fluid flow augmenting device 136 not only increases the volume of fluid flow through a single fluid circulation system, but it will also be appreciated that in applications with multiple fluid circulation systems, the fluid flow augmenting device 136 may be adapted to increase a total fluid flow through these fluid circulation systems. The increased or augmented fluid flow may be equal or unequal in each of the fluid circulation systems.

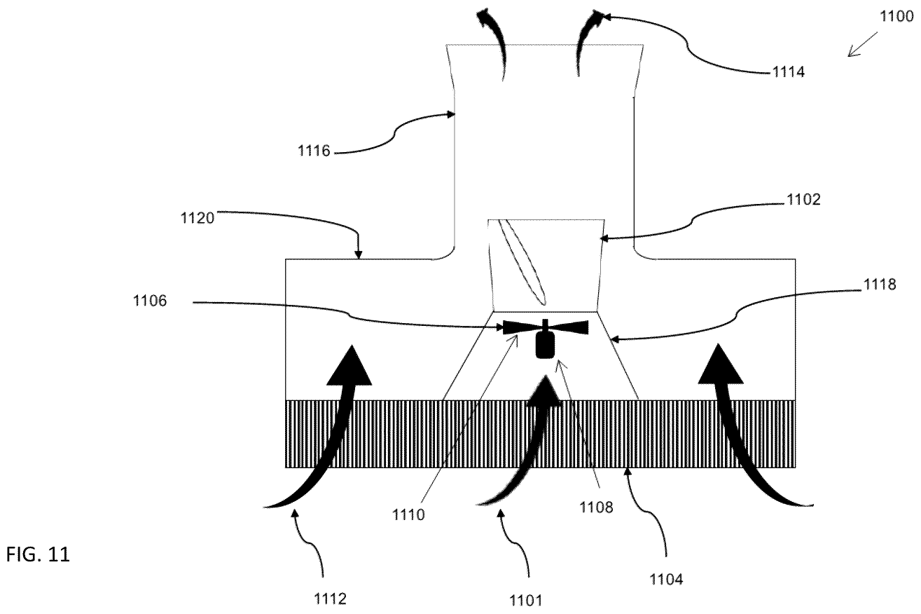

Referring now to FIGS. 11 through 22, some other implementations of the fluid flow augmenting device of the present disclosure are provided.

FIG. 11 illustrates an example of a radiator and horizontal condenser system 1100 including a fluid flow augmenting device 1102, according to another embodiment of the present disclosure. As illustrated, ambient air (shown as 1101) is drawn through a radiator coil 1104 by fan assembly 1106 including a motor 1108 and a fan 1110 having fan blades. Additional air (represented by 1112) may be entrained along with the air from the fan 1110 flowing from the fluid flow augmenting device 1102 to generate a combined airflow, which is then exhausted (as shown by 1114) from an exhaust stack 1116, in a similar manner, as described above. In this embodiment, the system 1100 may include one or more partitions 1118 configured to guide the airflow in a crosswind. As shown, the system 1100 may be supported by a housing 1120.

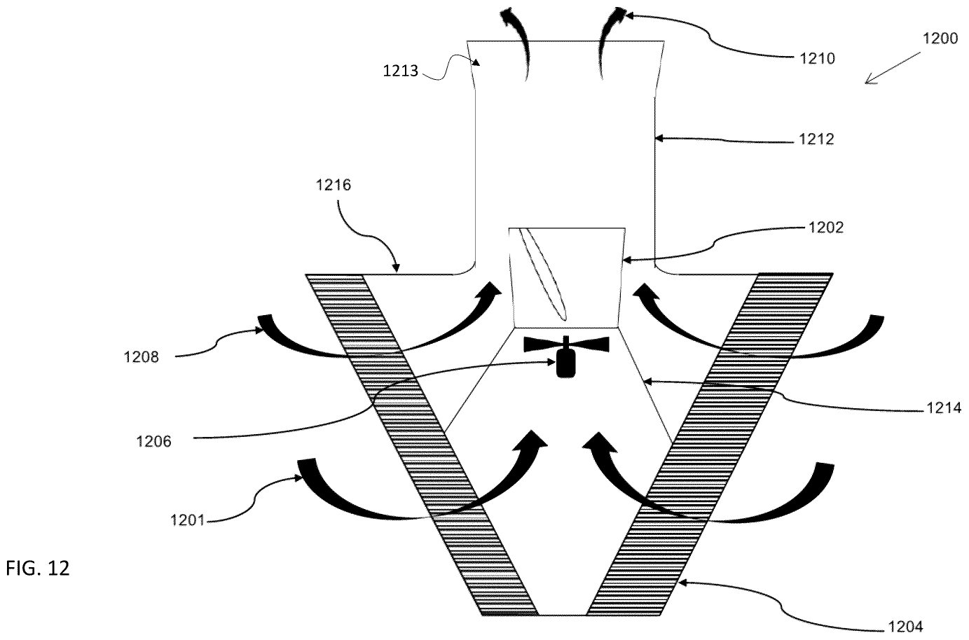

FIG. 12 illustrates an example of a dry air-cooled radiator system 1200 including the fluid flow augmenting device 1202 according to another embodiment of the present disclosure. As shown, ambient air (shown as 1201) is drawn through one or more radiator coils 1204 by a fan assembly 1206 including a motor and a fan having fan blades. The radiator coils 1204 may be one or more rows deep. Additional air (represented by 1208) may be entrained along with the air from the fan 1206 flowing from the device 1202 to generate a combined airflow, and warm air (represented by 1210) may be exhausted from the exhaust stack 1212 (and/or via velocity reducing section 1213), in a similar manner, as described above. In this embodiment, the system 1200 may include one or more partitions 1214 may be configured to guide the airflow in a crosswind. As shown, the system 1200 may be supported by a housing 1216.

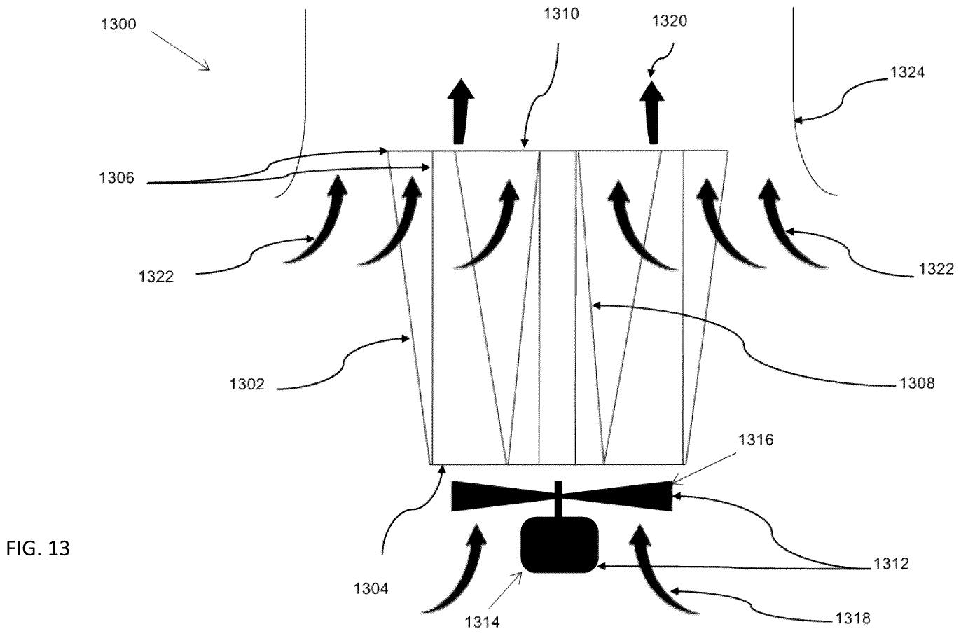

FIG. 13 illustrates an example of a system 1300 including a fluid flow augmenting device 1302 implemented with a mixing lobe design, in accordance with a yet another embodiment of the present disclosure. The system 1300 includes a bottom fan air inlet 1304, an outer radius 1306 of the mixing lobe, an inner radius 1308 of the mixing lobe, and an upper exhaust edge 1310 of the fluid flow augmenting device 1302. The fan assembly 1312 having a motor 1314 and a fan 1316 may be configured to draw in inlet air (shown by arrows 1318) and an exhaust air may flow up and out (shown by arrows 1320) the exhaust edge 1310. This may induce additional airflow (shown by arrows 1322) up through an exhaust stack 1324. Design features such as mixing lobes, scallops, ellipses, and chevrons may extend the length of an interface along the exhaust edge 1310 of the fluid flow augmenting device 1302, thereby promoting turbulent mixing with the fan airflow along with the entrained and induced airflow. The generation of vortices by these features may further improve performance. For example, the outer radius 1306 of the mixing lobe, an inner radius 1308 of the mixing lobe may be curved or angled in relation to the center axis of the system 1300 to generate increased turbulence, or vortex flow downstream of the upper exhaust edge 1310.

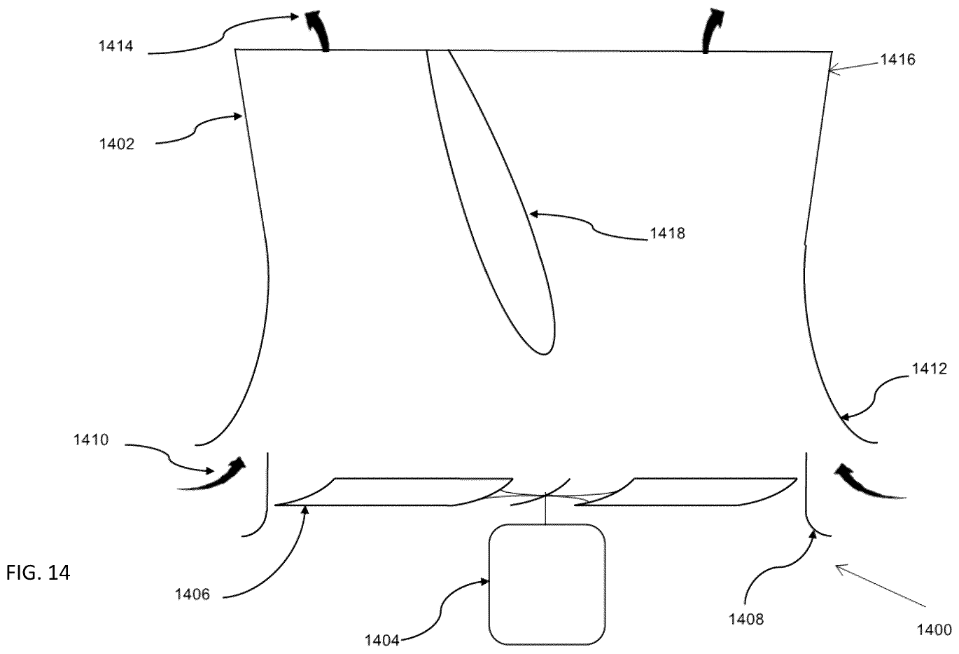

FIG. 14. Illustrates an alternate layout of the fan assembly 1400 that may be implemented for driving air into a fluid flow augmenting device 1402, in accordance with some additional or alternative embodiments of the present disclosure. The fan assembly 1400 includes a motor 1404 and fan 1406 having fan blades set within a fan inlet nozzle 1408 of the device 1402. Additional air 1410 may be drawn into a convergent section 1412 of the device 1402 and the exhaust air 1414 may exit an outlet section 1416 of the device 1402, in a similar manner as described above. In some examples, the outlet section 1416 may be suitably designed to promote entrainment of ambient air into the exhaust air 1414. One or more ducts 1418 may be used to draw air into a center of the device 1402. In some other implementations, an alternative to utilizing an eductor, a venturi, aspirating nozzle, injector, or ejector could also be employed. Further, a coanda surface may be installed downstream of the nozzle 1408 to induce or draw more air into the convergent section 1412. In this implementation of the device 1402, and also in some others, the inlet nozzle 1408 or equivalent component may be extended as a conduit to create an efficient layout of the device 1402 that will allow the device 1402 design to accommodate various geometric requirements of the application, as well as increase the induced and entrained flow rate. For example, the venturi, nozzle, ejector, injector, or eductor may be used to create high-velocity airflow with low pressure to induce and entrain increased airflow with the device 1402.

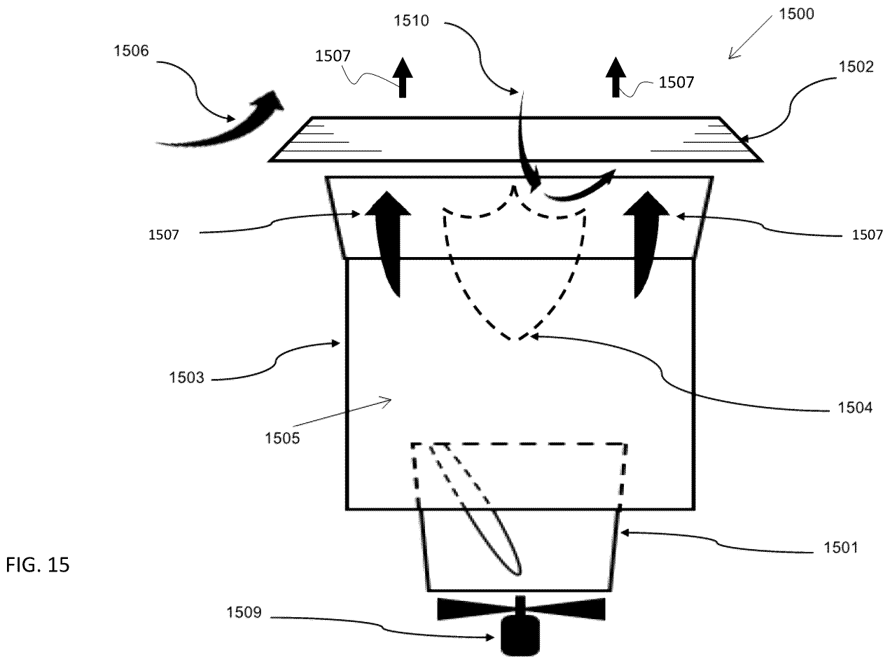

FIG. 15 depicts a system 1500 having a fluid flow augmenting device 1501, in accordance with some additional or alternative embodiments of the present disclosure. As shown, the system 1500 includes an exhaust assembly 1503 having an exhaust stack 1505. As shown, the exhaust assembly 1503 may further include a wind band 1502 mounted on the exhaust assembly 1503 and a fluid diode 1504 internal to the stack 1505. The wind band 1502, may be configured to add airflow efficiency to the exhaust flow in a crosswind, while the fluid diode 1504 may be configured to improve exhaust flow in a downwind situation. The wind band 1502 and fluid diode 1504 may be supported by internal strut supports and other structures (not shown). As illustrated in FIG. 15, the wind band 1502 may be configured to deflect a horizontal airflow of a cross wind (as shown by arrow 1506), to align with an exhaust flow 1507 (i.e., the combined airflow coming from a fan assembly 1509 via the fluid flow augmenting device 1501). Further, the fluid diode 1504 may be configured to redirect an airflow which is contrary to the exhaust (as shown by arrows 1510), to align with the exhaust flow 1507.

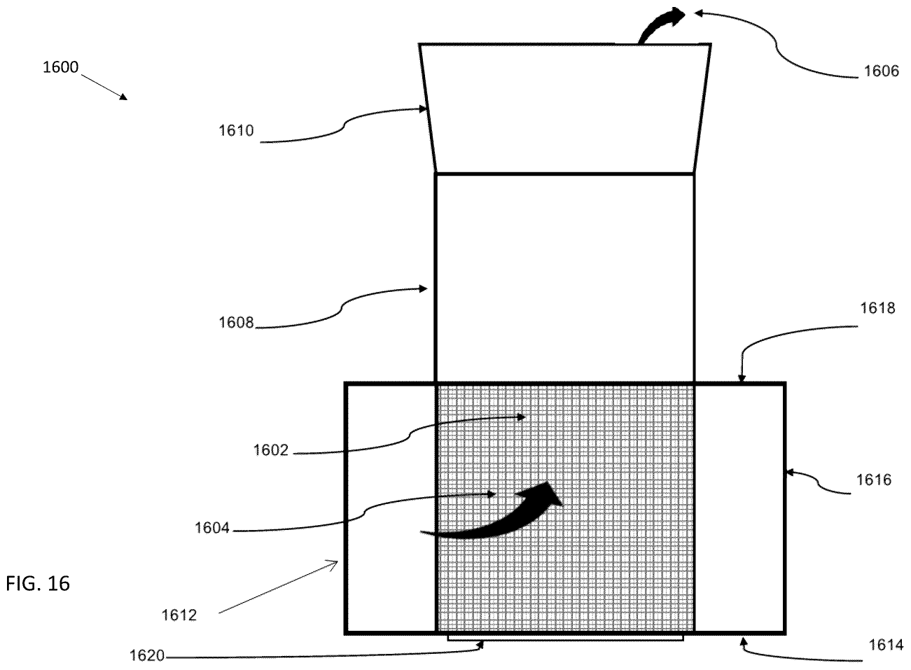

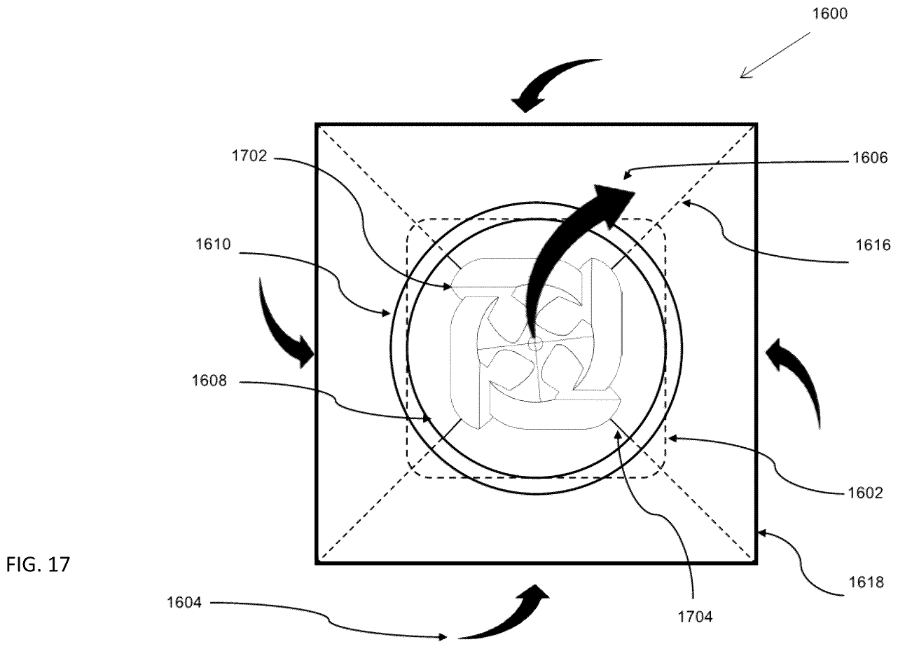

FIG. 16 illustrates an example of a system 1600 with an outer housing of an HVAC condenser assembly with air inlet extensions, in accordance with another embodiment of the present disclosure. As shown, the system 1600 includes a condenser assembly 1602 having a fluid flow augmenting device 1702 (shown in FIG. 17) and a fan assembly (not shown for the sake of simplicity) disposed therein, in a similar manner as described above. The internal fan and fluid flow augmenting device 1702 draw in cool ambient air 1604 through the condenser section 1602 guided by one or more outer partitions 1704 (similar to the outer partitions 310 described above) into the fluid flow augmenting device 1702. Heated exhaust air 1606, is expelled through an exhaust stack 1608, and velocity-reducing section 1610. In a crosswind environment, ambient air 1604 is guided into the condenser section 1602 by air inlet extensions 1612 which may include, as shown, a bottom panel 1614, a vertical outside edge of outer partition extensions 1616, and a top panel of an air inlet extension 1618. The dimensions and form of the air inlet extensions 1612 may be modified or increased to channel increased cool ambient air 1604 into the condenser assembly 1602. For example, the outer partition extensions 1616, and top panel of the inlet extension 1618 may be configured to channel airflow towards the center of the assembly. The entire assembly is supported by the base 1620, in a similar manner as already described. As will be appreciated, multiple fluid flow augmenting devices may be also installed to share a common exhaust flows, exhaust stack 1608, and/or the velocity-reducing section 1610.

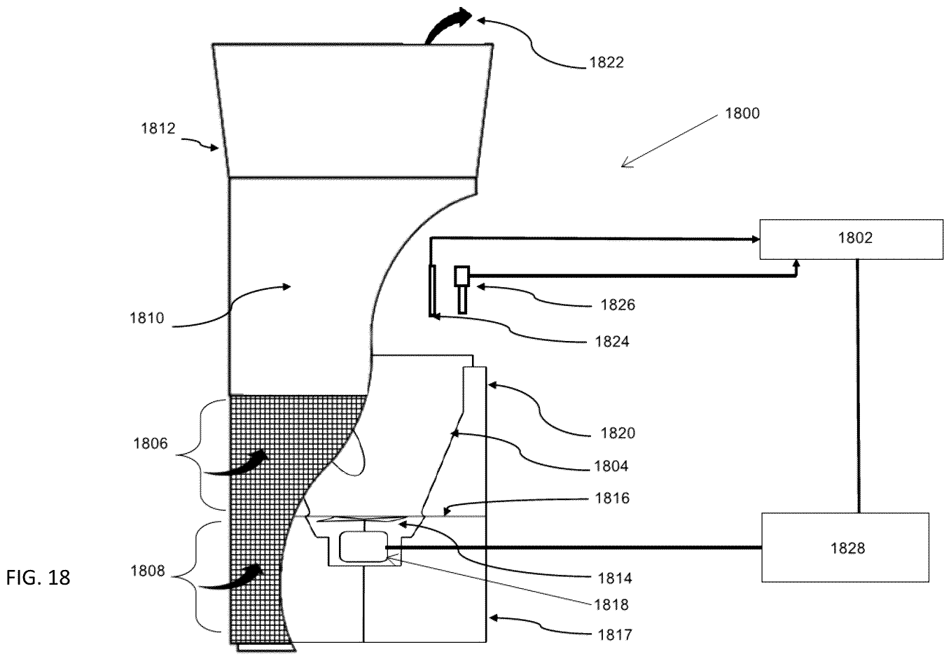

FIG. 18 illustrates an example of a system 1800, in accordance with an additional or an alternative embodiment of the present disclosure. As shown, the system 1800 may be electronically controlled by a controller 1802. To this end, the system includes a fluid flow augmenting device 1804, a condenser assembly having an upper condenser section 1806 and a lower condenser section 1808, an exhaust stack 1810, a velocity reducing section 1812, a fan assembly having fans 1814, supported on a table 1816 and table legs 1817 and driven by a motor 1818, and outer partition walls 1820. All these components are positioned and implemented in a similar manner as described previously.

As explained previously, the fan 1814 draws in cool ambient air through the lower condenser section 1808, and the fluid flow augmenting device 1804 draws in additional air through the upper condenser section 1806. Heated air 1822 is expelled through the exhaust stack 1810, and the velocity-reducing section 1812. In this implementation, the temperature of the airflow can be measured with an air temperature sensor 1824 while a rate of airflow may be measured by an airspeed sensor 1826. The air speed and temperature data may be transmitted to the controller 1802 that may implement a control logic to determine the most appropriate fan speed for the current environmental conditions and adjust the fan speed by communicating and controlling a motor speed controller 1828. In an example embodiment, as the crosswind increases, the controller 1802 may control the motor 1818 via motor speed controller 1828 and the fan motor speed may be reduced, for example, to maintain an equivalent airflow to a zero-crosswind condition. This will reduce the electrical consumption of the unit in crosswind applications. Further, the controller 1802 may be further configured to circulate refrigerant through the condenser assembly while the fan power is shut off, for example, to benefit from the airflow in a crosswind or ambient cooling. In some alternative implementations, a pressure sensor (not shown) may also be used instead of an air speed sensor to achieve similar results. Moreover, additional refrigerant temperature, ambient air temperature, airspeed, or pressure sensors (not shown) may also supply an input to the controller 1802 to monitor the atmospheric conditions and determine an optimum fan speed for the current environmental conditions. Further, although the sensors are shown and described to be positioned downstream of the fluid flow augmenting device 1802, it will be appreciated that this is one aspect of the description and that persons skilled in the art will understand that other sensor positionings are possible while achieving similar results.

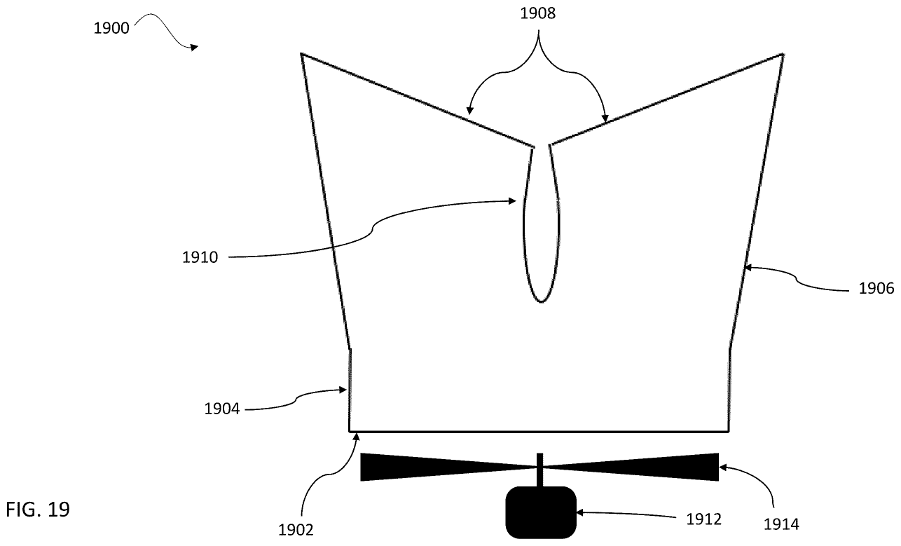

FIG. 19 illustrates an alternative design of a fluid flow augmenting device 1900 in accordance with another embodiment of the present disclosure. The fluid flow augmenting device 1900 includes a fan air inlet 1902 transitioning from the fan bell mouth to the device's outer cone 1904. The fluid flow augmenting device further includes an outer cone surface 1906 that extends up to exhaust surfaces 1908. In an example embodiment, the exhaust surfaces 1908 are angled to form an inverted chevron that is configured to contribute to the turbulent mixing of the airflows. In some other implementations, other shapes, such as but not limited to a partial ellipse may also be used instead of the chevron to encourage the turbulent mixing flow of the fan air streams with the perimeter and center airflow. In some additional or alternative implementations, the edge of the exhaust surfaces 1908, may also be fluted, scalloped, or the like to increase the length of the edge of the interface between the fan air, and the additional air drawn into the fluid flow augmenting device 1900. Furthermore, as illustrated, the fluid flow augmenting device 1900 includes one or more inlet ducting 1910 configured to allow air to flow into the center cone (not shown). A fan assembly having a motor 1912 and a fan 1914 having fan blades, are shown at the bottom of the fluid flow augmenting device 1900, such that the fan airflow, as well as air induced through the center of the device 1900 flows out through the exhaust 1908. Moreover, a downstream edge of the outer cone surface 1906 and an inner cone surface (not shown) may be parallel in relation to a center axis of the airflow or offset to contribute to inducing additional air.

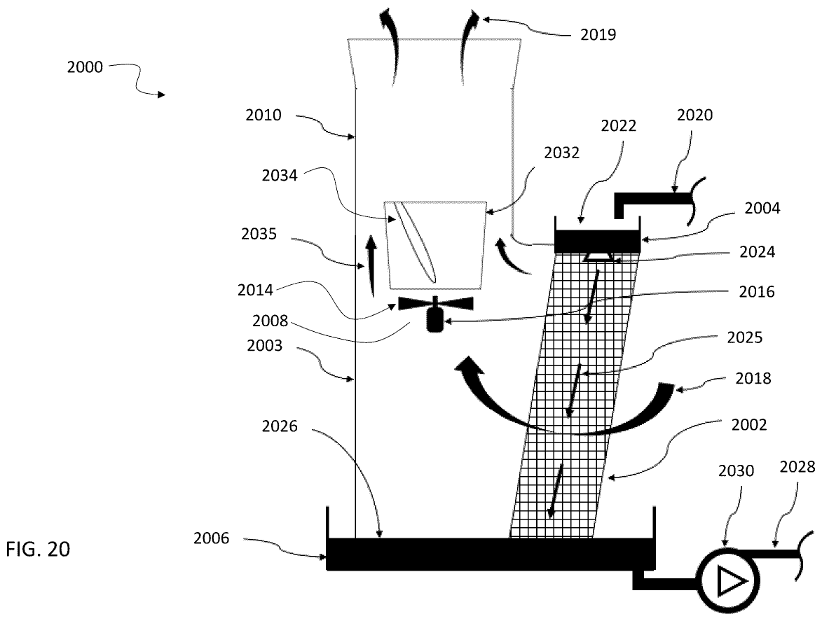

In another embodiment, FIG. 20 illustrates an example of a cooling tower 2000, according to an aspect of the present disclosure. The cooling tower 2000 may be embodied as a cross flow cooling tower, however, in other examples, it may be embodied as a counter flow cooling tower. The cooling tower 2000 includes one or more fill assemblies 2002 (only one shown in this example), a hot water distributor 2004 positioned above the fill assembly 2002, a cold-water collection basin 2006 positioned below the fill assembly 2002, a fan assembly 2008 and an exhaust stack 2010 supported by the top of the cooling tower 2000.

The fill assembly 2002 may include one or more fills that may be configured to act as a heat transfer medium where air interacts with and cools an evaporative liquid, such as hot water. The fill assembly 2002 may be implemented as a film fill having one or more sheets of material and/or a splash fill and may be configured to have additional patterns, such as crinkles, folds, and/or other types of channels to increase the cooling surface area and path for the hot water to travel. Further, as illustrated in FIG. 20, the cooling tower 2000 may include an asymmetric configuration, i.e., has a fill assembly 2002 on one side of the fan assembly 2008 and an external wall 2003 on the opposite side. However, in some other examples, the cooling tower 2000 may include a symmetrical configuration, i.e., one fill assembly 2002 provided on each side of the fan assembly 2008.

The fan assembly 2008 may include one or more fans 2014 and one or more motors 2016 (only one shown in FIG. 20) operatively coupled and configured to operate the fan 2014. In some implementations, a secondary fan may be positioned internally or externally to the fluid flow augmenting device 2032. For instance, a second fan may be set inside or downstream of the inner cone of the device 2032, where the inner cone may be kept larger than the second fan to enhance airflow efficiency. The fan assembly 2008 may be configured to rotate and draw in cool ambient air (shown by arrow 2018) through the fill assembly 2002 (which cools the hot water through heat transfer). Examples of the fan 2014 may include, but not limited to, a low-pressure axial fan, a propeller fan, a tube axial fan, a vane axial fan, a mixed-flow impeller fan, a centrifugal fan, and so on. The fan selection may depend on one or more variables associated with the application, such as flow requirements, pressure, power, or geometry of the application. In one example, the fan assembly 2008 may include a motor shaft and the fan 2014 may be mounted on the motor shaft to be driven by the motor 2016. In another example, the fan assembly 2008 may include a fan shaft and a motor shaft, both having sheaves, and a belt in contact with both the sheaves configured to transmit torque from the motor 2016 to the fan 2014. In a yet another example, the fan assembly 2008 may include the motor 2016, a gearbox, and a coupling between them configured to transmit torque to the fan 2014.

The exhaust stack 2010 may be configured to allow the exhaust air to be released (as shown by arrows 2019) into the environment via the outlet. The exhaust stack 2010 may, in some examples, be implemented as a conventional (traditional) stack and/or a velocity-reducing (recovery) stack, in which the airflow velocity may be diminished, and the horsepower requirement on the fan 2014 may be reduced. However, in some alternative embodiments, the exhaust stack 2010 may be formed into a nozzle shape or simply an orifice, configured to exhaust the airflow. Additionally, material to reduce acoustic emissions may be applied internally or externally to the exhaust stack 2010 and or other system components to reduce the noise levels emitted. Furthermore, insulation may also be applied to the components for increased thermal efficiency. It may be appreciated that the material used for insulation and noise reduction may be the same in some implementations.

In an example embodiment, the hot water distributer 2004 may receive hot water from a hot water piping 2020 and the collected hot water 2022 is distributed to the fill assembly 2002, via one or more openings or nozzles 2024. The hot water is cooled as it passes, e.g., falls and travels down (shown by arrows 2025), through the fill assembly 2002 and the cooled water is then collected in the cold-water collection basin 2006. Further, the cooled water 2026 is moved through a piping 2028, by a cooling water pump 2030, for example, to remove deposited liquid in the basin 2006 and/or for delivering the water to equipment requiring the same for cooling and/or returning the water to the supply source.

In an example embodiment, the cooling tower 2000 further includes a fluid flow augmenting device 2032 positioned in fluid communication with the fan assembly 2008 and the exhaust stack 2010 for enhancing the airflow through and around the fill assembly 2002 to improve its heat exchange capacity or the cooling capacity without significant additional power consumption. For example, the fluid flow augmenting device 2032 may be positioned upstream and/or downstream of the fan assembly 2008. Although only one fluid flow augmenting device is shown, it may be appreciated that the cooling tower 2000 may include multiple fluid flow augmenting devices positioned, for example, in parallel or in series/stages with one another and wherein the multiple fluid flow augmenting devices may combine the generated airflow into one or more exhausts and/or all be supplied by the airflow of one or more fans upstream of the device 2032. Each of the fluid flow augmenting devices may operate in a similar manner and/or cooperate with one another to further augment the fluid flow and improve the heat exchange capacity.

The fluid flow augmenting device 2032 may be implemented and may function in a similar manner as described above. For example, the fluid flow augmenting device 2032 may include ducts 2034 that may be configured to entrain and/or induce additional air (such as that shown by arrows 2035) along with the fan air from the fan assembly 2008 to generate a combined airflow and warm air is exhausted from the stack 2010, in a similar manner as already described above. A combined airflow rate of the combined airflow is greater than the first airflow rate from the fan assembly 2008 and the combined airflow impinges on the fill assembly 2002. The fluid flow augmenting device 2032, in this example, may also be positioned on a support table configured to support the fan assembly 2008 and create a partition for the airflow upstream the fan assembly 2008 from the airflow adjacent to it. An air inlet divider (not shown) may additionally be positioned around the table and may be configured to separate the lower airflow drawn in below the device 2302 through the fan assembly 2008, from the upper airflow entrained and induced through the fluid flow augmenting device 2032. Table legs and outer partition walls may also be positioned in a similar manner as described above to facilitate effective drawing of additional air through the fluid flow augmenting device 2032 and inhibit crosswind from passing through the cooling tower 2000. The table legs may be set in a cross pattern from corner to corner in a four-sided tower, or straight across the middle of a two-sided cooling tower.

Further, the high-speed fan air exiting the fluid flow augmenting device 2032 may be configured to cause the air around the perimeter of upper outside edge of the device 2032 to move in the same direction through the entrainment process. The total exhaust airflow is comprised of the fan airflow, induced air in the central chamber of the fluid flow augmenting device 2032, and the entrained air around the perimeter of the device 2032. Further, in some embodiments, the three airflows may combine downstream of the fluid flow augmenting device 2032, while in some alternative or additional embodiments, the three airflows may combine within the internal volume of the fluid flow augmenting device 2032. In some additional or alternative implementations, the fluid flow augmenting device 2032 may be designed to solely utilize the third airflow around the perimeter to be combined with the first airflow from the fan assembly 2008. Furthermore, in case of employing multiple fluid flow augmenting devices, it may be appreciated that each device may create its respective combined airflow in a similar manner.

In an example embodiment, the fluid flow augmenting device 2032 may additionally include vortex generation (not shown) to create a swirl pattern to the exhaust flow of the multiplier. For example, the vortex generation may be achieved by angling the aero foil ducting 2034 of the fluid flow augmenting device 2032. Furthermore, one or more internal partitions positioned in the inner cone of the device 2032 may be angled to align with the angling of the ducts 2034 to further enhance the airflow. Additionally, the exhaust surfaces may be inclined with the conduits 512 to contribute to vortex flow. In other applications, a portion of one of the flows may be divided off and reintroduced at an angle to the original flows to contribute to a vortex. Alternatively, another fan, or an external flow may be introduced to generate vortex flow.

The fluid flow augmenting device 2032 results in improved overall cooling rates for a given footprint and power consumption of the cooling tower 2000. The device 2032 may deliver, for example, a 10% greater airflow for a given energy consumption or a 10% lower energy consumption compared to the airflow of a same system without such a device. In some examples, without an ambient crosswind, the cooling tower 2000 having the fluid flow augmenting device 2032 may have an increased fluid flow in a range of about 34% to 55% drawn through the fill assembly 2002 with less than 0 to 1% increase in power consumption. In some other examples, when operating with an ambient crosswind in a range of about 4 meters per second (m/s) to 8 m/s, the cooling tower 2000 having the fluid flow augmenting device 2032, may have an increased fluid flow in a range of about 40% to 62% drawn through the fill assembly 2002 with less than 0 to 1% increase in power consumption.

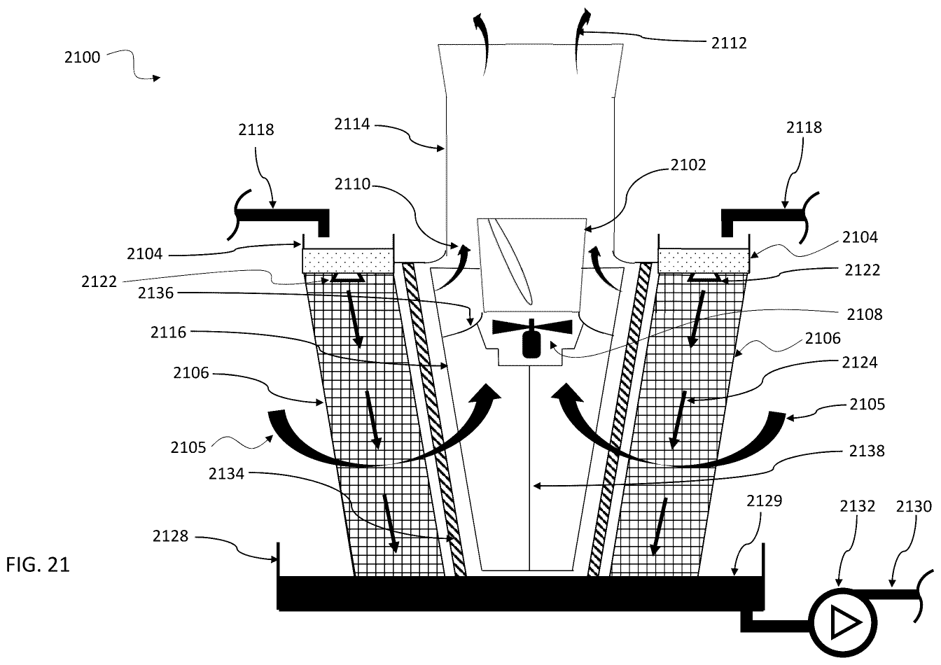

FIG. 21 illustrates another example of cooling tower 2100 having a fluid flow augmenting device 2102 according to an embodiment of the present disclosure. In this example, the cooling tower may include multiple hot water basins 2104 and fill assemblies 2106, such as positioned symmetrically around the fan assembly 2108. Although only two hot water basins and fill assemblies are shown and described, it may be contemplated that a cooling tower assembly with four or any other number of hot water basins and fill assemblies may be implemented to achieve similar results.

As illustrated, cool ambient air (shown by arrows 2105) is drawn through the fill assemblies 2106 (thermal exchange surface) by the fan assembly 2108 having one or more fans and motors. Additional air, shown by arrows 2110 is entrained along with the air from the fan flowing from the fluid flow augmenting device 2102 and warm air (shown by arrows 2112) is exhausted from the exhaust stack 2114. In the illustrated embodiment, the cooling tower 2100, may include an outer wall partition 2116 that may be configured to prevent ambient air from passing directly through the cooling tower 2100 and guide it up towards the fluid flow augmenting device 2102. The fluid flow augmenting device 2102 or the features it has, may, in some embodiments, be rotated around its vertical axis for the most airflow efficient alignment with the outer wall partitions 2116. The outer wall partitions 2116 design may also be altered to accommodate a tower layout with: one or more hot water basins 2104, a tower with a modular design, or multiple towers side by side.

Further, piping supplies hot water 2118 which flows into the hot water basin 2104 that is further distributed through nozzles 2122. The falling hot water (shown by arrows 2124), is cooled as it travels down through the fill assemblies 2106 into the cold-water basin 2128. The cooled water 2129 may then be moved through the piping 2130, by a cooling water pump 2132. In some embodiments, when viewed from above, the outer edges of the cold-water basin 2128, may form a square, or other shape depending on the form of the hot water basin 2104 or fill of the cooling tower design.

In the illustrated embodiment, a drift eliminator 2134 may be configured to reduce the amount of water droplets carried by the airflow, out through the exhaust stack 2114. Further, an air inlet divider 2136 separates the airflow drawn in by the fan assembly 2108, from the additional air 2110 which is entrained & induced through the fluid flow augmenting device 2102, which is located above a center axis 2138 of the outer wall partition 2116.

The fluid flow augmenting devices presented herein may be utilized with a cross flow cooling tower as illustrated, counter flow cooling tower, or hybrid of both designs. The airflow may be induced or forced. The fluid flow augmenting device may also be used in wet cooling towers, dry cooling towers, or towers with combined wet and dry sections.

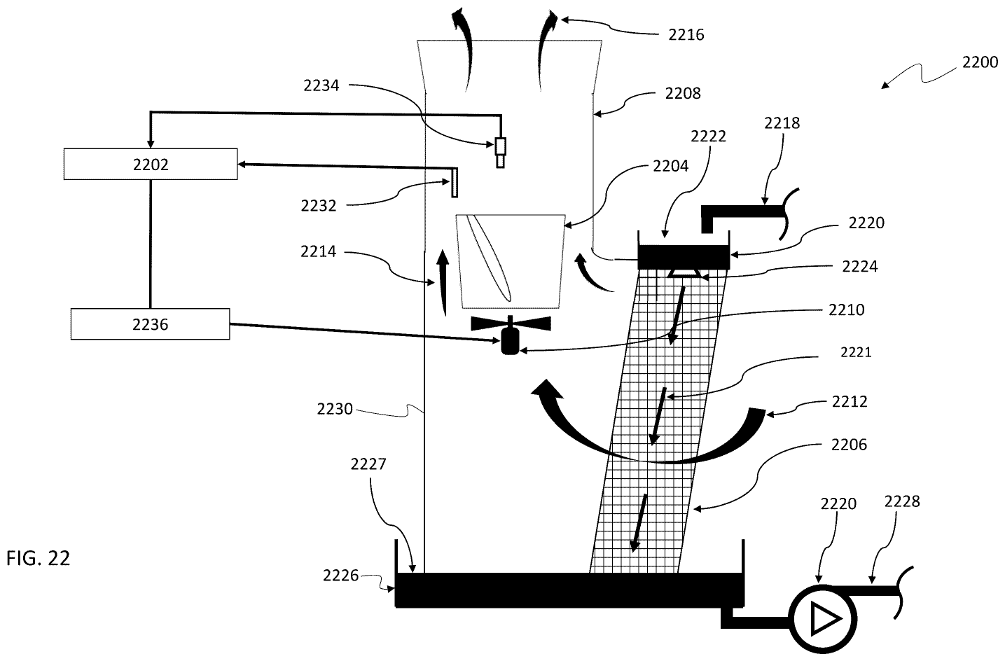

In a yet another embodiment, FIG. 22 illustrates an example of a cooling tower 2200 that may be electronically controlled by a controller 2202. To this end, the cooling tower 2200 includes a fluid flow augmenting device 2204, one or more fill assemblies 2206, an exhaust stack 2208, and a fan assembly 2210 having one or more fans driven by a motor. All these components are positioned and implemented in a similar manner as described previously.

In operation, cool ambient air (as shown by arrows 2212), is drawn through the fill assemblies 2206 (thermal exchange surface) by the fan assembly 2210. Additional air, such as that shown by arrows 2214) is entrained and induced along with the air from the fan flowing from the fluid flow augmenting device 2204, and warm air, as shown by arrows 2216, is exhausted from the exhaust stack 2208. Hot water 2218 flows into a hot water basin 2220 and the collected hot water 2222 is further distributed through nozzles 2224. The falling hot water, shown by arrows 2221 is cooled as it travels down through the fill assemblies 2206 into the cold-water basin 2226. The cooled water 2227 is moved through the piping 2228, by a cooling water pump 2220. As illustrated, the cooling tower may be asymmetrical with an outer wall 2230 opposite the fill symmetrical with fill assemblies on both sides of the fan assembly 2210. In this example, a temperature of the airflow can be measured with an air temperature sensor 2232 and a rate of airflow may be measured by an air speed sensor 2234. The air speed and temperature data can be fed into the controller 2202, which can determine the appropriate fan speed for the current environmental conditions and adjust the fan and motor speed via a motor speed controller 2236. For instance, when the cross-wind increases, the fan motor speed May be reduced to maintain an equivalent airflow to a zero cross wind condition, which reduces the electrical consumption of the cooling tower in cross wind applications. Further, it may be appreciated that an additional temperature sensor (not shown) may also supply an input to the control logic to measure the ambient temperature to determine the optimum fan speed for the current environmental conditions. In some alternative implementations, a pressure sensor (not shown) may also be used instead of an air speed sensor to achieve similar results. Moreover, additional refrigerant temperature, ambient air temperature, airspeed, or pressure sensors (not shown) may also supply an input to the controller 2202 to monitor the atmospheric conditions and determine an optimum fan speed for the current environmental conditions.

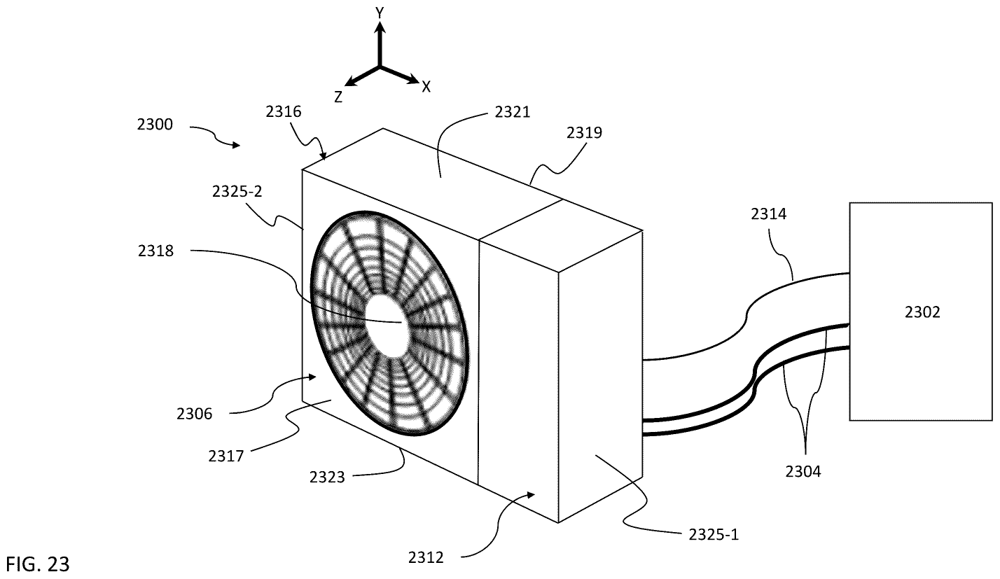

Referring now to FIGS. 23 through 33, some yet other implementations of the fluid flow augmenting device of the present disclosure are provided.

FIGS. 23 through 25 illustrate an example of an outdoor unit assembly 2300 according to an alternative embodiment of the present disclosure. In this embodiment, the outdoor unit assembly 2300, hereinafter referred to as the outdoor unit 2300, may be implemented as a side or horizontal discharge assembly as opposed to the vertical discharge assemblies described above. The outdoor unit 2300 may, in some examples, be part of a split or mini-split HVAC or heat pump system with a side discharge. As will be appreciated, the outdoor unit 2300 may be positioned or mounted on, for example, a roof of a building, affixed to a wall, or adjacent to a building. The outdoor unit 2300 may be fluidly connected to an indoor unit 2302 via one or more refrigerant lines 2304 that transfer the refrigerant in liquid form in one direction and return the vaporized refrigerant in an opposite direction.

The outdoor unit 2300 may include a condenser section 2306 having a fan assembly 2308 configured to draw in cool ambient air through one or more condenser coils 2310. The outdoor unit 2300 further includes a compressor section 2312 configured to circulate the refrigerant between the condenser coils 2310 and a heat exchanger unit (not shown) of the indoor unit 2302. As will be appreciated, the compressor section 2312 also includes one or more controls and connects to the incoming power via power line 2314. As illustrated, the compressor section 2312 is positioned beside the condenser section 2306 in a side-to-side discharge configuration, however, in other implementations, it may be oriented below or above the condenser section 2306, for achieving the most appropriate layout according to its desired application. The components of the outdoor unit 2300 are enclosed in a housing 2316 that includes a front panel 2317, a back panel 2319, a top panel 2321, a bottom panel 2323 and two side panels 2325-1, 2325-2. A guarding grill 2318 is installed in the front panel 2317 to protect from the rotating fan assembly 2308 and the high-temperature elements of the outdoor unit 2300 inside the housing 2316.

In an embodiment, the outdoor unit 2300 includes a fluid flow augmenting device 2320 configured to augment the fluid flow through and around the condenser coils 2310. The fluid flow augmenting device 2320 is positioned in fluid communication with the fan assembly 2308. For example, the fluid flow augmenting device 2320 may be positioned downstream and/or upstream of the fan assembly 2308, and although only one fluid flow augmenting device 2320 is shown and described, it may be appreciated that in this implementation as well, the outdoor unit 2300 may include multiple fluid flow augmenting devices positioned in parallel and/or in series with one another.

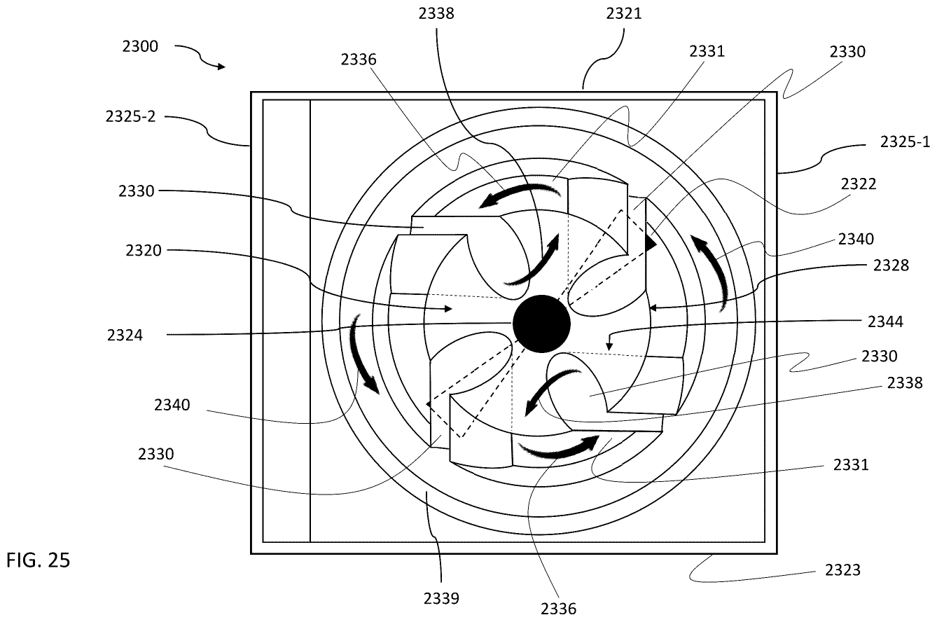

The fan assembly 2308 includes one or more fans 2322 and one or more motors 2324 operatively coupled to drive the one or more fans 2322 via fan shaft(s) 2327. Rotation of the fan(s) 2322 draws the fan air through the condenser coils 2310. The fluid flow augmenting device 2320 may be positioned in front of the fan assembly 2308 inside the housing 2316, oriented laterally between the front panel 2317 and the back panel 2319, such that the longitudinal axis of the device 2320 is parallel to the z-axis of the outdoor unit 2300, as illustrated. However, it may be appreciated that any other orientation and positioning of the fluid flow augmenting device 2320 may also be implemented to achieve similar results. Similar to the fluid flow augmenting devices described above, the fluid flow augmenting device 2320 in this embodiment also includes an outer cone 2326, an inner cone 2328, one or more ducts 2330 and one or more conduits 2331 (shown in FIG. 25) cooperating to augment the fluid or airflow from the fan assembly 2308 in a similar manner as described above.

The fluid flow augmenting device 2320, hereinafter referred to as the device 2320, includes a fan air inlet 2332 on one longitudinal end positioned towards the back panel 2319 of the housing 2316 and in fluid communication with the fan assembly 2308. In one example, the fan air inlet 2332 is configured to surround the tip of the blades of the fan 2322 and support the outer cone 2326 of the device 2320. The device 2320 further includes an inlet edge 2334 through which the fan air, i.e., the first airflow (shown by arrows 2336) having first airflow rate, drawn through the condenser coils 2310, enters the device 2320. Further, the device 2320 defines an air outlet 2337 on the other longitudinal end that is positioned proximal to the front panel 2317 of the housing 2316 and in communication with a curved exhaust radius 2339 of the housing 2316 to allow the exhaust air to exit. The fan air inlet 2332 is configured to transition to the outer cone 2326 and the downstream walls of the outer cone 2326 may be contoured to taper away from a central axis of the device 2320 to have a larger opening at the air outlet 2337, thereby forming a conical shape for the device 2320. It may be appreciated that in some other implementations, the downstream walls of the outer cone 2326 may be contoured to a variety of tapers or may even be parallel to match the layout of the housing 2316 to achieve similar results.

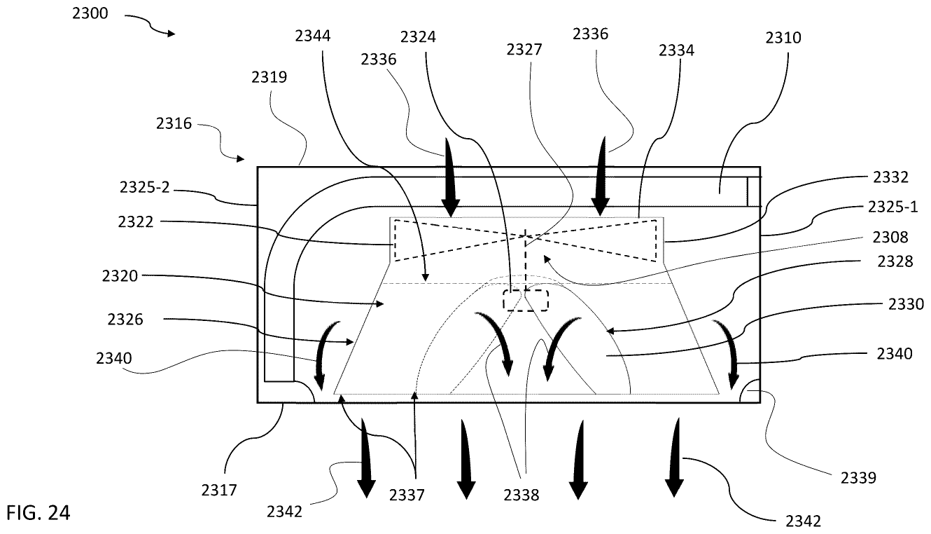

In operation, as shown in FIGS. 24 and 25, the conduits 2331 are configured to receive the fan airflow, i.e., the first airflow 2336 having first airflow rate, and guide the air through the perimeter of the device 2320 laterally towards the exhaust radius 2339. The ducts 2330 are configured to draw in or induce additional ambient air (i.e., ‘second airflow’, shown by arrows 2338) having second airflow rate into the internal volume of the device 2320, i.e., the inner cone 2328, in a similar manner as described previously. This additional ambient air supplements the first airflow 2336 from the fan 2322 to generate a combined airflow exiting the device 2320 via the air outlet 2337.

In an embodiment, the ducts 2330 may have rounded edges and rounded ends, such as that shown towards a duct bottom end 2344 and may be angled downstream with respect to a central axis of the device 2320 to allow the rotational or swirling flow of air downstream of the device 2320. In one example implementation, the ducts 2330 may be angled with respect to the axis of the device 2320 by an angle in the range of about 10 degrees and 80 degrees. In some implementations, the ducts 2330 may be positioned perpendicular to the center axis of the fan airflow or may be defined at an angle of axis between 10 degrees and 180 degrees, based on the desired application and airflow efficiency.

Additionally, in some example implementations, the ducts 2330 may be positioned at equal angular distances from one another and the duct bottom end 2344 of each of the ducts 2330 may be positioned at approximately equal linear distance from the fan 2322. In some alternative examples, the ducts 2330 may be placed at unequal angular distances from one another, but the duct bottom end 2344 of each of the ducts 2330 may be positioned at approximately equal linear distance from the fan 2322. In some yet other examples, the duct bottom end 2344 of at least some of the ducts 2330 may be placed at unequal linear distances from the fan 2322. The ducts 2330 may be in the form of an airfoil, a coanda surface, a venturi, an aspirating nozzle, an ejector, an injector, an eductor, or the like.

In some embodiments, one or more orifices and/or passages (not shown) may be provided to the inner cone 2328 and/or the ducts 2330, to allow the high-velocity first airflow from the fan 2322 to add to the induced second airflow and motivate the induced second airflow towards the curved exhaust radius 2339 of the housing 2316 to allow the exhaust air to exit. These orifices and passages may also be used to assemble one or more fluid flow augmenting devices 2320 in series or in parallel downstream of the first fluid flow augmenting device 2320. The orifices may be set out in a symmetrical or an asymmetrical layout, with varied lengths and angles from the center axis of the device 2320.

Further, an annular space defined between the device 2320 and the housing 2316, for example, the space between the device 2320 and the top panel 2321, the space between the device 2320 and the side panels 2325 and the space between the device 2320 and the bottom panel 2323 may be configured to allow a ‘third airflow’ (shown by arrows 2340) having a third airflow rate to be entrained around the perimeter of the device 2320 and drawn through the condenser coils 2310 to combine with the first and second airflows. As explained previously, in some embodiments, the third airflow may be configured to not pass through the internal volume of the device 2320 to supplement the first and second airflows. The three airflows combine to generate the total combined airflow (shown by arrows 2342) drawn through the device 2320, and the condenser coils 2310 for cooling of the refrigerant within the coils. In some embodiments, the three airflows may combine downstream of the fluid flow augmenting device 2320, while in some alternative or additional embodiments, the three airflows may combine within the internal volume of the device 2320.

It may be appreciated that the fluid flow augmenting device 2320 may be configured to modify the first airflow 2336 to generate the combined airflow 2342 via one or more of a non-vortex turbulent motion, non-vortex laminar motion, or a vortex. Further, the fluid flow augmenting device 2320 may be designed to create either the second airflow and/or the third airflow in any desired ratio as they combine into the total flow of the device 2320. In some additional or alternative implementations, the fluid flow augmenting device 1202 may be designed to solely utilize the third airflow around the perimeter to be combined with the first airflow from the fan 2322. Furthermore, in case of employing multiple fluid flow augmenting devices, it may be appreciated that each device may create its respective combined airflow in a similar manner.

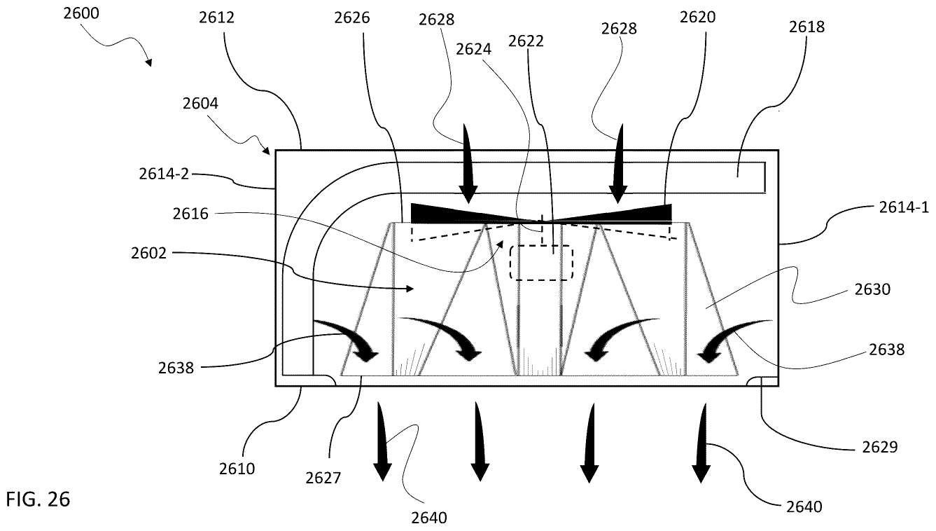

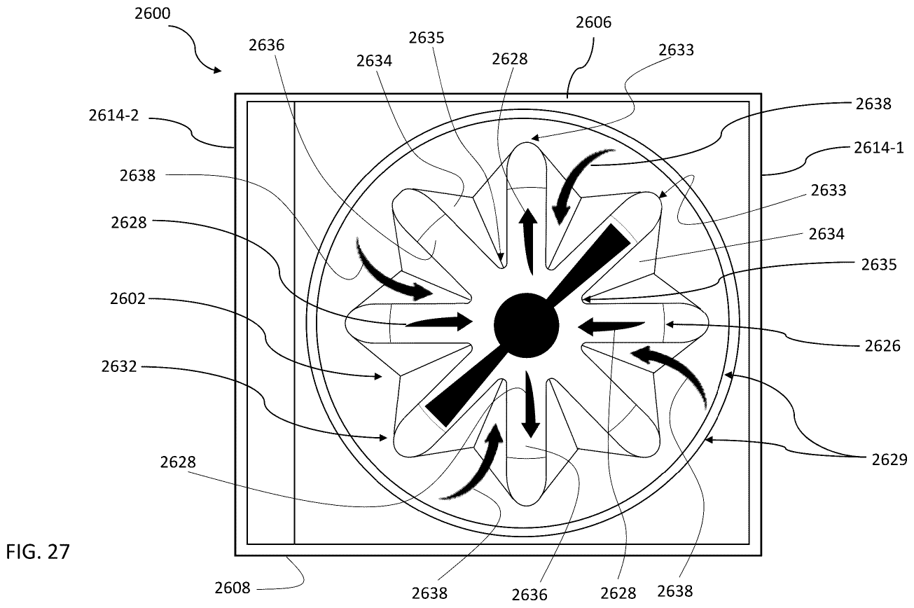

FIGS. 26 and 27 illustrate an alternative implementation of the fluid flow augmenting device 2602 provided within an outdoor unit assembly 2600 implemented as a side or horizontal discharge assembly. In this embodiment, the fluid flow augmenting device 2602 is implemented with a mixing lobe design. The outdoor unit 2600 includes a housing 2604 having a top panel 2606, a bottom panel 2608, a front panel 2610, a back panel 2612, and side panels 2614. The outdoor unit 2600 may include a condenser section having a fan assembly 2616 configured to draw in cool ambient air through one or more condenser coils 2618. The outdoor unit 2600 further includes a compressor section (not shown) configured to circulate the refrigerant between the condenser coils 2618 and a heat exchanger unit (not shown) of the indoor unit.

The fan assembly 2616 includes one or more fans 2620 and one or more motors 2622 operatively coupled to drive the one or more fans 2620 via fan shaft(s) 2624. Rotation of the fan(s) 2620 draws the fan air through the condenser coils 2618. The fluid flow augmenting device 2602 may be positioned in front of the fan assembly 2616 inside the housing 2604, oriented laterally between the front panel 2610 and the back panel 2612, as illustrated. It May be appreciated that in other implementations, when the fluid flow augmenting device with mixing lobe design is included in a vertical discharge assembly, the fluid flow augmenting device May be positioned vertically over the fan assembly in a stacked configuration, as explained in previous embodiments above.

The fluid flow augmenting device 2602 is positioned in fluid communication with the fan assembly 2616 and configured to augment the fluid flow through and around the condenser coils 2618. In this embodiment, the fluid flow augmenting device 2602 includes a fan air inlet 2626 which partially covers the fan assembly 2616 and is configured to receive the first airflow (shown by arrows 2628) having first airflow rate drawn through the condenser coils 2618 and entering into the internal volume of the device 2602. Further, the device 2602 defines an air outlet 2627 that is positioned proximal to the front panel 2610 of the housing 2604 and in communication with a curved exhaust radius 2629 of the housing 2604 to allow the exhaust air to exit.

In an embodiment, the fan air inlet 2626 may transition to an external wall 2630 of the device 2602, which includes a number of alternating lobes 2632 extending around the perimeter of the device 2602. Each lobe 2632 defines a crest (e.g., crest 2633) and a trough (e.g., 2635), such that the external surface between two crests forms an external air channel 2634, and an internal surface between two troughs forms an internal air channel 2636 that cooperates with other internal air channels and external air channels to augment the fluid or airflow from the fan assembly 2616 in a similar manner, as described above. In an example embodiment, the external wall 2630 may be contoured to taper away from a central axis of the device 2602 to have a larger outer circumference towards the air outlet 2627. However, it May be appreciated that the external wall 2630 may be contoured to a variety of tapers or may even be parallel to match the layout of the housing 2604 to achieve similar results.

The internal air channels 2636 may be configured to receive the fan airflow, i.e., the first airflow 2628 having first airflow rate, and guide the air through the perimeter of the device 2602 towards the exhaust radius 2629. Further, the external air channels 2634 may be configured to allow an additional airflow (shown by arrows 2638) having a different airflow rate to be entrained around the perimeter of the device 2602 and drawn through the condenser coils 2618 to combine with the first airflow and generate a combined airflow (shown by arrows 2640) that exits the device 2602. As with the third airflows described in other embodiments, the additional airflow in this implementation too, may be configured to not pass through the internal volume of the device 2602 and may be configured to combine with the first airflow 2628 downstream of the device 2602 and subsequently exit via the air outlet 2627.

In some embodiments, design features such as mixing lobes, scallops, ellipses, and chevrons may extend the length of an interface along the outlet 2627 of the fluid flow augmenting device 2602, thereby promoting turbulent mixing with the fan airflow along with the entrained and induced airflow. The generation of vortices by these features may further improve performance.

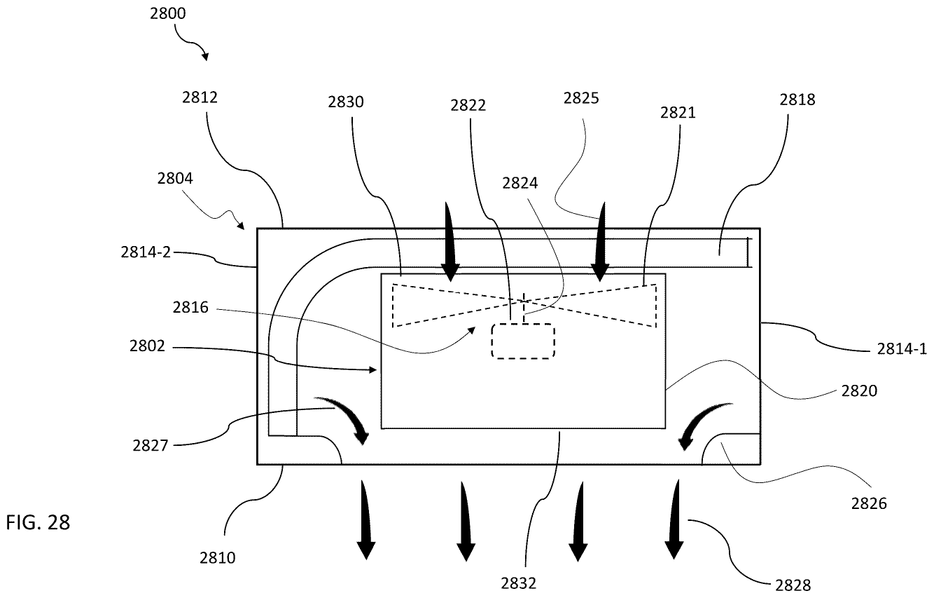

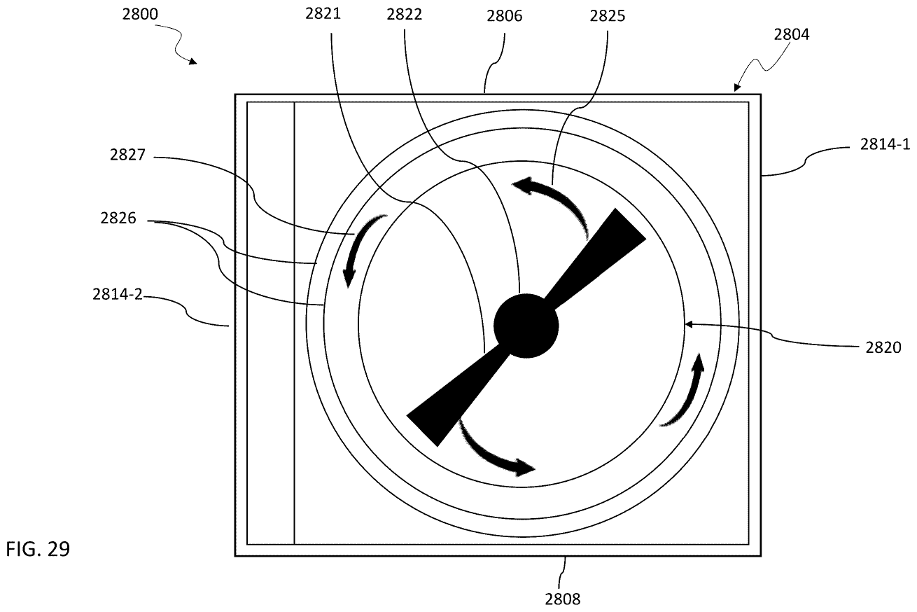

FIGS. 28 and 29 illustrate a yet another implementation of the fluid flow augmenting device 2802 provided within an outdoor unit assembly 2800. In the illustrated embodiment, the fluid flow augmenting device 2802 is implemented with an eductor nozzle design. The outdoor unit 2802 includes a housing 2804 having a top panel 2806, a bottom panel 2808, a front panel 2810, a back panel 2812, and side panels 2814-1 and 2814-2 (collectively referred to as side panels 2814). The outdoor unit 2800 may include a condenser section having a fan assembly 2816 configured to draw in cool ambient air through one or more condenser coils 2818. The outdoor unit 2800 further includes a compressor section (not shown) configured to circulate the refrigerant between the condenser coils 2818 and a heat exchanger unit (not shown) of the indoor unit.

The fan assembly 2816 is set within a fan inlet nozzle 2820 of the device 2802 and includes one or more fans 2821 and one or more motors 2822 operatively coupled to drive the one or more fans 2821 via fan shaft(s) 2824. The rotation of the fan(s) 2821 draws the fan air through the condenser coils 2818. In an example embodiment, the fan inlet nozzle 2820 may be implemented as a standalone fluid flow augmenting device that is fluidly coupled to receive the fan air, i.e., the first airflow (shown by arrows 2825) from the fan 2821 and induce additional air to be drawn into a convergent section 2826 that transitions to an air outlet of the outdoor unit 2800. However, in some other implementations, the fan inlet nozzle 2820 may be implemented as an add-on device in addition to one or more of the fluid flow augmenting device, according to any of the embodiments described above. In such implementations, the fan inlet nozzle 2820, may be implemented as the fan air inlet or may be fluidly coupled to the fan air inlet of the fluid flow augmenting device.

The fan inlet nozzle 2820 includes an air inlet edge 2830 that has an inlet radius to simulate the bell mouth radius described above. Further, the fan inlet nozzle 2820 includes an outlet surface 2832 through which the exhaust air exits the fan inlet nozzle 2820 and, in this example, the outdoor unit 2800. In some examples, the outlet surface 2832 of the fan inlet nozzle 2820, and the corresponding surface of the convergent section 2826 may be suitably designed to promote entrainment of ambient air through the implementation of mixing lobes, chevron patterns, scalloping, fluting, vortex generators, or the like.

In the illustrated embodiment, the first airflow 2825 may be configured to enter the internal volume of the fan inlet nozzle 2820 and additional air, i.e., second airflow (shown by arrows 2827) having a second airflow rate may be drawn through the condenser coils 2818, around the perimeter of the fan inlet nozzle 2820. For example, the fan air or the first airflow exiting the nozzle 2820 may be configured to motivate or draw the additional air to be induced around the perimeter. The induced airflow is further drawn into the convergent section 2826 that transitions to exhaust an exhaust air out from the outlet of the outdoor unit 2800. The exhaust air (shown by arrows 2828) is a combination of the first airflow 2825 from the fan 2821 and the additional air (or the second airflow 2827) drawn around the perimeter of the nozzle 2820. In some examples, one or more ducts may be used to draw air into a center of the device 2802. In some other implementations, an alternative to utilizing an eductor, a venturi, aspirating nozzle, injector, or ejector could also be employed. Further, a coanda surface may be installed downstream of the nozzle 2820 to induce or draw more air into the convergent section 2826. In this design of the device 2802, the fan inlet nozzle 2820 or equivalent component may be extended as a conduit to create a layout of the fluid flow augmenting device 2802 that accommodates various geometric requirements of the application, as well as increase the additional airflow 2827 flow rate. In some alternative embodiments, the fluid flow augmenting device 2802 may be oriented upstream of the condenser coil 2818, guiding vanes, or turning, or straightening vanes may be additionally used to improve airflow efficiency. Each of these components may be positioned upstream or downstream, in parallel, or integrated into the fluid flow augmenting device 136. Additionally, straight or curved inclined planes may be included into the assembly to guide efficient airflow.

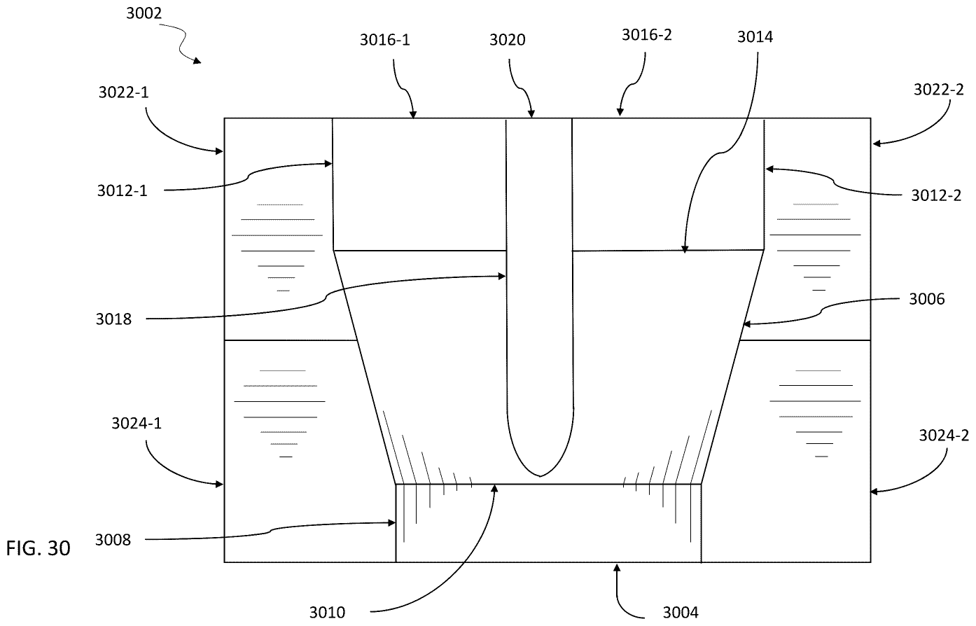

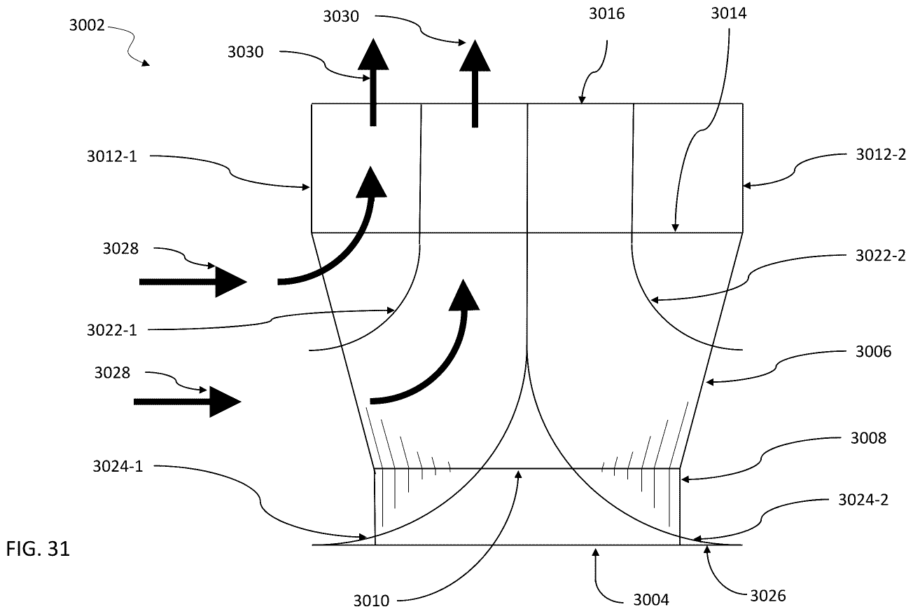

Referring now to FIGS. 30 and 31, an example of a fluid flow augmenting device 3002 implemented with flow turning structures, such as turning vanes is illustrated. In some embodiments, the fluid flow augmenting device 3002 may be structurally similar to the fluid flow augmenting device 136. However, the structural configuration of the fluid flow augmenting device 3002 may be implemented according to any other embodiments described above. As illustrated, a fan air inlet 3004 may transition to the outer cone 3006 to define a fan transition area 3008 of the fluid flow augmenting device 3002. The outer cone 3006 may be angled away from a transition cone base 3010, towards the external walls 3012 which extend up from a transition point 3014 around the perimeter of an outlet 3016 of the device 3002. In one embodiment, the device 3002 includes one or more ducts 3018, which allow additional airflow to be induced through the center of the device 3002, are enclosed by the outer cone 3006, and the external walls 3012. The device 3002 may further include one or more internal partitions 3020 (similar to the internal partitions 802 described above) to prevent the induced airflow from passing through the device 3002, and instead redirect the induced airflow with the outlet 3016.

In an example embodiment, one or more turning vanes are provided to further enhance the fluid flow efficiency of the fluid flow augmenting device 3002. In the illustrated embodiment, a first or upper set of turning vanes 3022 and a second or lower set of turning vanes 3024 are integrated into the exterior of the device (e.g., outside the device 3002 and inside a housing of the heat exchanger or condenser assembly in which the device 3002 is implemented). The first or upper set of turning vanes 3022 may be stacked on top of the second or lower set of turning vanes 3024. However, this configuration is one aspect of the description and other configurations of turning vanes may also be implemented to achieve similar results. The turning vanes may be suitably angled to redirect entrained airflow around the side of the device 3002. In one example, the turning vanes in each of the first set 3022 and the second 3024 may be angled with respect to the longitudinal axis of the device 3002 so as to redirect the entrained airflow around the device 3002 to align with the outlet 3016. Alternatively, additional turning vanes angled horizontally, for example, may be provided so as to channel the airflow into the ducts 3018 of the device 3002.

As shown in FIG. 31, the fan air inlet 3004 may be supported on and aligned with a support member 3026 (such as a table similar to the table 306 described above), which also supports the second or lower set of turning vanes 3024 and the fan transition area 3008. As illustrated, the entrained horizontal airflow (shown by arrows 3028) from around the device 3002 is rotated by the first set of turning vanes 3022 and the second set of turning vanes 3024 to become vertical airflow (as shown by arrows 3030) to be aligned with the augmented airflow exiting the outlet 3016 of the fluid flow augmenting device 3002. Thus, the turning vanes further increase the overall fluid flow efficiency of the device 3002 and the fluid circulation system in which the device 3002 is implemented.

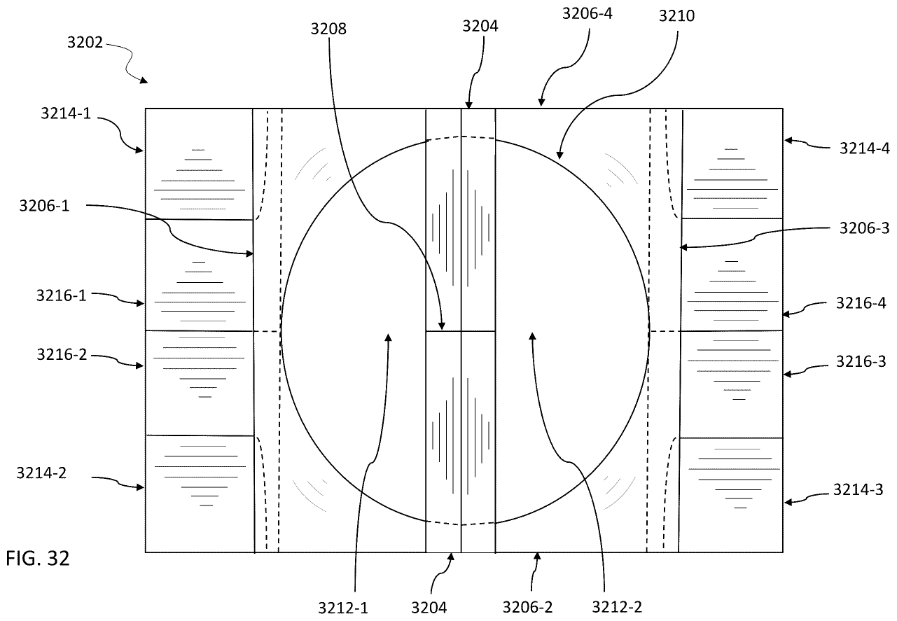

Referring now to FIG. 32, a yet another implementation of the fluid flow augmenting device 3202 with turning vanes is illustrated. In one example implementation, the fluid flow augmenting device 3202 may include one or more ducts 3204 extending through the device 3202 and connecting to the external walls 3206 on each side. As will be appreciated, the ducts 3204 may be increased or decreased in volume to accordingly alter the induced airflow from around the device 3202. The device 3202 may further include one or more internal partitions 3208 (similar to the partitions 802 described above) positioned in the center of the internal volume of the device 3202, which divides the internal volume above the fan transition area 3210 into two sections 3212-1, 3212-2 (collectively referred to as 3212). These two sections 3212 define the conduits (hereinafter referred to as the conduits 3212) for receiving the first airflow from the fan assembly (not shown) in a similar manner as described above for conduits 512. In some implementations, the volume of the ducts 3204 may be altered to replace the function of the inner partitions 3208 and achieve similar results.

As further shown, a first or upper set of turning vanes 3214 and a second or lower set of turning vanes 3216 may be provided external to the device 3202 (such as between the device 3202 and the housing of heat exchanger or condenser assembly) to redirect the airflow to align with the exhaust exiting the outlet of the device 3202. As illustrated, the first set of turning vanes 3214 and the second set of turning vanes 3216 are visible surrounding the external walls 3206 of the device 3202. The turning vanes 3214 and 3216 are angled so as to coordinate to redirect the horizontal airflow from around the device 3202 and align (in this case in the vertical direction) with the augmented airflow exiting via the outlet of the device 3202. Alternatively, the turning vanes 3214 and 3216 may be angled so as to direct the airflow into the ducts 3204 instead of directing them to align with the outlet of the device 3202.

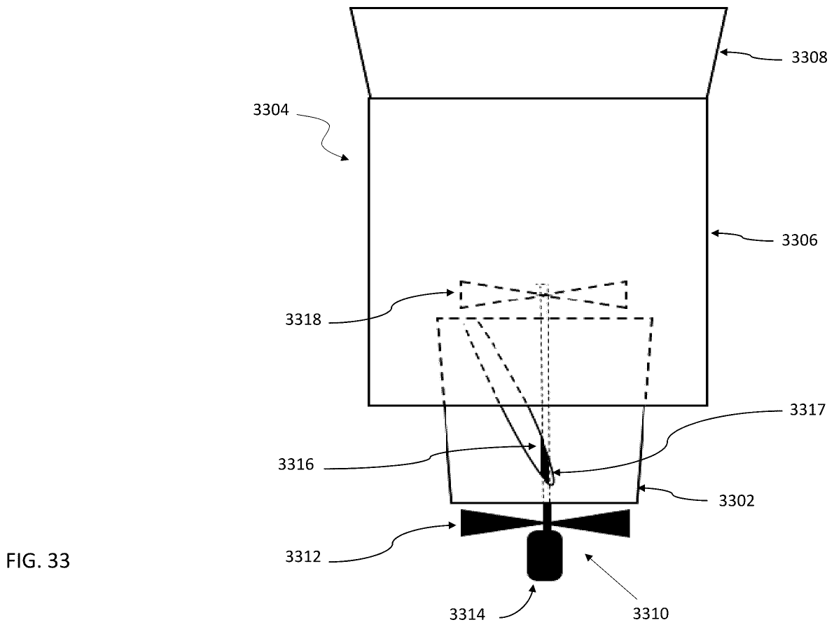

Referring now to FIG. 33, a fluid flow augmenting device 3302 according to a yet another embodiment is illustrated. In this embodiment, the fluid flow augmenting device 3302 is implemented with two fans to further enhance the augmented airflow circulating through the device 3302 and outputting therefrom. In the illustrated example, the fluid flow augmenting device 3302 is fluidly connected to an exhaust assembly 3304 having an exhaust stack 3306 and a velocity reduction section 3308 (implemented in a similar manner as described for previous embodiments above). As illustrated, the device 3302 is fluidly connected to a fan assembly 3310 that operates to draw a first airflow into the internal volume of the device 3302. In an example embodiment, the fan assembly 3310 includes a first fan 3312 and a motor 3314 operatively connected to drive the first fan 3312. The fan assembly 3310 further includes a shaft 3316 (visible with the duct 3317) connected at one end to the first fan 3312 and the motor 3314 and connected at the other end to a second fan 3318. As illustrated, the first fan 3312 is positioned upstream of the device 3302 while the second fan 3318 is positioned downstream of the device 3302. However, such a configuration is according to one aspect and it may be varied to achieve similar results. For example, in some implementations, both the fans 3312, 3318 may be positioned upstream of the device 3302 or in some other implementations, the second fan may be positioned internal to the device 3302. Further, although the fans 3312 and 3318 are shown and described to be operated via the shaft 3316, in some other implementations, these fans 3312, 3318 may alternatively be driven by a drive system incorporating a belt and sheaves arrangement, or a gearbox, or via coupling to transmit the torque from the motor 3314.

As the motor 3314 and the first fan 3312 rotate, they also drive and rotate the second fan 3318 via the shaft 3316 to increase the airflow through the device 3302 as well as the exhaust exiting via the exhaust assembly 3304, i.e., via the exhaust stack 3306 and the velocity reduction section 3309. The additional airflow achieved by the second fan 3318 further enhances the heat exchanging capacity of the heat exchanger in which the fluid flow augmenting device 3302 and the fan assembly 3310 are implemented.

The structural features of the various implementations of the fluid flow augmenting device are described herein in terms of one or more aspects of the description and persons skilled in the art will appreciate that the device may be formed in any suitable configuration and dimensions to suit various applications without deviating from the scope of the subject matter claimed herein. Further, the steps or operations in the diagrams described herein are merely for example. There may be many variations to these steps or operations without departing from the principles discussed above. For instance, the steps may be performed in a differing order, or steps may be added, deleted, or modified.

Although the above description includes reference to certain specific embodiments, various modifications thereof will be apparent to those skilled in the art. Any examples provided herein are included solely for the purpose of illustration and are not intended to be limiting in any way. Any drawings provided herein are solely for the purpose of illustrating various aspects of the description and are not intended to be drawn to scale or to be limiting in any way. The scope of the description should not be limited by the preferred embodiments set forth herein but should be given the broadest interpretation consistent with the present specification as a whole as would be understood by persons skilled in the art. The disclosures of all prior art recited herein are incorporated herein by reference in their entirety.

### EXAMPLES

Wind Tunnel Testing Results with an Example Fluid Flow Augmenting Device Installed in an Example HVAC Condenser:

Three HVAC condenser assemblies were tested in a wind tunnel to measure airflow and power. The three assemblies were labeled:
1. OEM—This layout is a typical HVAC condenser with a fan mounted on the top of the unit.
2. MOD—This layout uses the same fan as the OEM layout; however, the fan is positioned lower in the unit with a fluid flow augmenting device. An exhaust stack is also mounted to the HVAC condenser.
3. MODBOX—This layout is the same assembly described in the MOD layout; however, extensions have been added to the air inlet of the HVAC condenser coil to direct more airflow through the system in a crosswind.

The performance of the three HVAC condensers were measured with zero crosswind, ambient crosswind of 4 m/s (meters per second) and ambient crosswind of 8 m/s. The results concluded:
1. The unit with the fluid flow augmenting device (i.e., the MOD) produced increased airflow compared to the OEM unit.
2. The unit with the fluid flow augmenting device required less power to operate the fan motor.
3. The airflow through the exhaust stack mounted on the MOD unit increased as the ambient air crosswind speed increased.
4. Inlet extensions on the MODBOX unit further increased performance.

The measurements are listed in Table 1.

TABLE 1

| | | | Airflow percentage |
|---|---|---|---|
| | Crosswind | | compared to |
| Layout | M/S | Flow CFM | OEM layout |
| OEM | 0 | 1636 | 100.0000 |
| MOD (fluid flow | 0 | 2195 | 134.1687 |
| augmenting device) | | | |
| MOD (fluid flow | 4 | 2301 | 140.6479 |
| augmenting device) | | | |
| MOD (fluid flow | 8 | 2632 | 160.8802 |
| augmenting device) | | | |
| MODBOX (fluid flow | 8 | 2640 | 161.3692 |
| augmenting device | | | |
| with air inlet | | | |
| extensions) | | | |

In evaluation of the performance, Fan Laws (also known as Affinity Laws) may be used to calculate potential energy savings.

### Fan Law 1

Fan Law 1 provides that the change in airflow rate of a fan is proportional to the change in speed of the propeller. If the propeller speed is increased by 10%, the airflow rate will also increase by 10%. This is expressed as:

$$\frac{{Q}_{1}}{{Q}_{2}} = \frac{{N}_{1}}{{N}_{2}}$$

Q1=OEM fan airflow in CFM
Q2=The increased flow of the OEM fan to match the fluid flow augmenting device CFM
N1=The original OEM fan speed (rpm)
N2=The increased OEM fan speed to match the flow rate of the fluid flow augmenting device CFM

Due to the efficiency of the fluid flow augmenting device, the fan rpm can be slowed down to provide an equivalent airflow to an OEM fan.

Example 1: 100% OEM fan airflow/134. 17% fluid flow augmenting device efficiency=74.53% of the original airflow required for the MOD fan.

Since the propeller speed and airflow are proportional, if the fluid flow augmenting device requires 74.53% of the fan airflow, the motor RPM can be reduced to 74.53% or the OEM speed as well. The fan law 1 equation has been used to populate the OEM fan rpm increase in table 2 below.

### Fan Law 3

Fan Law 3 provides that the change in horsepower required by the fan to turn the propeller will increase by the cube of the change in propeller speed of the fan. Fan law 3 is expressed:

$$\frac{{P}_{1}}{{P}_{2}} = {( \frac{{Q}_{1}}{{Q}_{2}} )}^{3}$$

P1=Power in the first operating condition
P2=Power in the second condition
Q1=The initial flow rate (cfm)
Q2=The final flow rate (cfm)

If the propeller speed is increased by 10%, the horsepower required to turn the propeller will increase 33.1%. Also, if the propeller speed is reduced by 10%, the horsepower required to turn the fan propeller will decrease by 27.1% to 72.9% of the power originally required.

Fan Law 3 was used to calculate the OEM fan power increase required to produce an equivalent flow of an assembly with a fluid flow augmenting device, where:
P1 is the power required for the OEM fan motor in the traditional layout.
P2 is the power required for the OEM fan motor to increase in speed to match the fluid flow augmenting device flow.
Q1 is the original fan airflow rate of the OEM fan layout.
Q2 is the flow rate the fluid flow augmenting device that the OEM fan speed is being increased to match in flow.

TABLE 2

| | | | | OEM fan | OEM power | Percentage | % Increase |
|---|---|---|---|---|---|---|---|
| | | | | RPM | ratio | of power | of OEM fan |
| | | | Fan | increase to | increase | required for | motor |
| | | | motor | equal flow | required to | OEM fan to | power to |
| | | | amps | rate of the | equal the | equal the | equal the |
| | Cross- | | measured | fluid flow | fluid flow | fluid flow | fluid flow |
| Unit | wind | Flow | during | augmenting | augmenting | augmenting | augmenting |
| Tested | (m/s) | (CFM) | testing | device | device CFM | device CFM | device CFM |
| OEM - | 0 | 1636 | 0.82 | N/A | N/A | N/A | |
| Design | | | | | | | |
| baseline | | | | | | | |
| MOD (fluid | 0 | 2195 | 0.780 | 1.342 | 2.415 | 241.520 | 141.520 |
| flow | | | | | | | |
| augmenting | | | | | | | |
| device) | | | | | | | |
| MOD (fluid | 4 | 2301 | 0.766 | 1.406 | 2.782 | 278.227 | 178.227 |
| flow | | | | | | | |
| augmenting | | | | | | | |
| device) | | | | | | | |
| MOD (fluid | 8 | 2632 | 0.744 | 1.609 | 4.164 | 416.397 | 316.397 |
| flow | | | | | | | |
| augmenting | | | | | | | |
| device) | | | | | | | |
| MODBOX | 8 | 2640 | 0.748 | 1.614 | 4.202 | 420.206 | 320.206 |
| (fluid flow | | | | | | | |
| augmenting | | | | | | | |
| device with | | | | | | | |
| air inlet | | | | | | | |
| extensions) | | | | | | | |

Table 2 notes:
1. The increased resistance of the airflow through the condenser coil has not been accounted for in calculating the power increase of the OEM fan to match the fluid flow augmenting device performance.
2. Assuming equivalent thermal performance of the OEM system and the fluid flow augmenting device system.
3. The power requirement of the fluid flow augmenting device decreased in cross wind testing.

Test Results with a Higher Velocity Fan:

The performance of a fluid flow augmenting device prototype was tested with a higher airflow 16.5″ (419 MM) fan and exhaust stack installed on a conventional air conditioning condenser. The condenser coil had a 17.4 square foot area. The condenser with a fan, fluid flow augmenting device, and exhaust stack produced 169% of the airflow, when compared to the fan mounted alone directly on the top of condenser in a traditional manner. The assembly with the fluid flow augmenting device and exhaust stack required less than a one percent increase in power when compared to the fan mounted alone on top of the condenser. See test results below:

Fan Alone Mounted on Condenser

| | | |
|---|---|---|
| Fan diameter | 16.5 | inch |
| Fan exhaust area (motor area excluded) | 1.45 | Square feet |
| Air speed (average) | 1,273.45 | Feet/minute |
| Airflow | 1,846.5 | Cfm |

Fan With a Fluid Flow Augmenting Device and an Exhaust Stack

| | | |
|---|---|---|
| Exhaust stack area | 5.81 | Square feet |
| Air speed (average) | 537.49 | Feet/minute |
| Airflow | 3,122.8 | Cfm |

| | |
|---|---|
| Increase in Airflow | 169% |

The increase in power required for the fan alone to match the equivalent flow of the fan and fluid flow augmenting device through the exhaust stack can be shown as:

1.69\hat{ }3=4.83

In other words, it would take the fan motor 483% of the energy to increase the flow of the fan, to match the fan and fluid flow augmenting device and exhaust stack assembly.

Test Results with a Small-Scale Fluid Flow Augmenting Device:

Performance measurement of a fluid flow augmenting device prototype with a 3-inch (80-millimeter) fan air inlet and exhaust stack produced 148% of the airflow of the fan alone. See test results below:

Fan Alone

| | | |
|---|---|---|
| Fan diameter | 3 | inch |
| Fan area | 0.0541 | Square feet |
| Air speed (average) | 3,622 | Feet/minute |
| Airflow | 195.95 | Cfm |

Fan With an 80 mm Fluid Flow Augmenting Device

| | | |
|---|---|---|
| Exhaust stack area | 0.25 | Square feet |
| Air speed | 1,160.8 | Feet/minute |
| Airflow | 290.2 | Cfm |

| | |
|---|---|
| Increase in Airflow | 148% |

The increase in power required for the fan alone to match the equivalent flow of the an and fluid flow augmenting device through the exhaust stack can be shown as:

1.48\hat{ }3=3.24

In other words, it would take the fan motor 324% of the energy to increase the flow of the fan, to match the fan and the fluid flow augmenting device and exhaust stack assembly.

1. A fluid flow augmenting device for a fluid circulation system, the fluid flow augmenting device comprising:
an annular body extending along a longitudinal axis of the fluid flow augmenting device and defining an internal volume of the fluid flow augmenting device, the annular body including:
a fluid inlet on one longitudinal end and a fluid outlet on another longitudinal end along the longitudinal axis;
a first fluid directing structure adapted to receive a first fluid flow with a first fluid flow rate from a fluid source via the fluid inlet and direct the received first fluid flow into the internal volume of the fluid flow augmenting device; and
a second fluid directing structure adapted to induce a second fluid flow having a second fluid flow rate from around the fluid flow augmenting device to be combined with the first fluid flow to generate an augmented fluid flow having an augmented fluid flow rate to be exhausted via the fluid outlet, wherein the augmented fluid flow rate is greater than each of the first fluid flow rate and the second fluid flow rate;
wherein the second fluid directing structure includes one or more ducts provided in the annular body, each of the one or more ducts being fluidly disconnected from the fluid inlet and adapted to entrain the second fluid flow from around the fluid flow augmenting device into the internal volume of the annular body to generate the augmented fluid flow to be exhausted via the fluid outlet.

2. The fluid flow augmenting device of claim 1, wherein the annular body includes one or more external walls extending between the longitudinal ends and adapted to define a periphery of the fluid flow augmenting device, and wherein the first fluid directing structure includes one or more conduits defined by the respective one or more external walls, the conduits being positioned about the periphery and fluidly connected to the fluid inlet to receive the first fluid flow.

3. The fluid flow augmenting device of claim 2, wherein each of the one or more conduits includes a hollow cross-sectional profile having one or more fluid contact surfaces adapted to guide the first fluid flow into the respective conduits, the internal volume of the fluid flow augmenting device and towards the fluid outlet.

4. The fluid flow augmenting device of claim 2, wherein the one or more conduits are spaced apart and angled with respect to one another to define the second fluid directing structure therebetween.

5. The fluid flow augmenting device of claim 1, wherein each of the one or more ducts has a closed end proximal to the fluid inlet and an open end proximal to the fluid outlet, each of the one or more ducts having an axis of symmetry angled downstream with respect to the longitudinal axis of the fluid flow augmenting device.

6. The fluid flow augmenting device of claim 5, wherein the axis of symmetry of the one or more ducts is angled downstream by an angle within the range of 10 degrees and 80 degrees with respect to the longitudinal axis of the fluid flow augmenting device.

7. The fluid flow augmenting device of claim 6, wherein the one or more ducts are positioned in one of the following configurations:
a) each of the one or more ducts being positioned at an equal angular distance from one another and having the closed end positioned at an equal linear distance from the fluid source;
b) each of the one or more ducts being positioned at an unequal angular distance from one another and having the closed end positioned at an equal linear distance from the fluid source; and
c) one or more of the ducts having the closed end positioned at an unequal linear distance from the fluid source.

8. The fluid flow augmenting device of claim 1, wherein the annular body includes one or more external walls adapted to define an annular space with respect to a housing of the fluid circulation system, the annular space being adapted to entrain a third fluid flow having a third fluid flow rate around a perimeter of the fluid flow augmenting device to be combined with the augmented fluid flow prior to being exhausted via the fluid outlet.

9. The fluid flow augmenting device of claim 1, wherein the second fluid directing structure is operatively connected to one or more flow-turning structures positioned around the fluid flow augmenting device to redirect the second fluid flow to be aligned with the fluid outlet.

10. (canceled)

11. The fluid flow augmenting device of claim 1 having a form factor comprising a conical, round, square, elliptical, triangular, lobed, or a squircle profile.

12. The fluid flow augmenting device of claim 1, wherein the fluid outlet defines an exhaust edge for exhausting the augmented fluid flow therefrom, the exhaust edge including one or more of mixing lobes, scalloped edges, elliptical pattern, partial ellipse, and one or more chevrons having a scalloped pattern.

13. The fluid flow augmenting device of claim 1, wherein one or more of the fluid inlet, the fluid outlet, the first fluid directing structure, and the second fluid directing structure includes rounded edges to provide smooth fluid flow therethrough.

14. The fluid flow augmenting device of claim 1, wherein the first fluid directing structure and the second fluid directing structure are adapted to generate one or more of a non-vortex turbulent motion, non-vortex laminar motion, or a vortex motion for combining the first fluid flow and the second fluid flow.

15. The fluid flow augmenting device of claim 1, wherein the second fluid directing structure is in the form of an airfoil, a coanda surface, a venturi, an aspirating nozzle, an ejector, an injector, and or an eductor.

16. The fluid flow augmenting device of claim 1 further comprising one or more internal partitions positioned within the internal volume, each of the one or more internal partitions being angled to define an aerodynamic profile and adapted to complement and align with a profile of the second fluid directing structure.

17. The fluid flow augmenting device of claim 1, wherein the annular body includes a plurality of alternating lobes, each lobe defining a respective crest and trough, and wherein the annular body defines a plurality of external fluid channels each being defined between two crests and a plurality of internal fluid channels each being defined between two troughs, and wherein the first fluid directing structure includes the plurality of internal fluid channels and the second fluid directing structure includes the plurality of external fluid channels.

18. (canceled)

19. A fluid circulation system comprising:
a heat transfer system;
a fan assembly for circulating fluid through the heat transfer system;
an exhaust assembly; and
a fluid flow augmenting device fluidly connected to the fan assembly and the exhaust assembly to augment the fluid circulating through the heat transfer system, the fluid flow augmenting device including:
an annular body extending along a longitudinal axis of the fluid flow augmenting device and defining an internal volume of the fluid flow augmenting device, the annular body including:
a fluid inlet on one longitudinal end and a fluid outlet on another longitudinal end along the longitudinal axis;
a first fluid directing structure to receive a first fluid flow with a first fluid flow rate from the fan assembly via the fluid inlet and direct the received first fluid flow into the internal volume of the fluid flow augmenting device; and
a second fluid directing structure adapted to induce a second fluid flow having a second fluid flow rate from around the fluid flow augmenting device to be combined with the first fluid flow to generate an augmented fluid flow having an augmented fluid flow rate to impinge on the heat transfer system and be directed to the exhaust assembly via the fluid outlet, wherein the augmented fluid flow rate is greater than each of the first fluid flow rate and the second fluid flow rate;
wherein the second fluid directing structure includes one or more ducts provided in the annular body, each of the one or more ducts being fluidly disconnected from the fluid inlet and adapted to induce the second fluid flow from around the fluid flow augmenting device into the internal volume of the annular body to generate the augmented fluid flow to be exhausted via the fluid outlet.

20. The fluid circulation system of claim 19, wherein the heat transfer system is positioned upstream of the fan assembly or downstream of the fluid flow augmenting device.

21. (canceled)

22. The fluid circulation system of claim 19, wherein the heat transfer system comprises a first heat transfer section and a second heat transfer section, wherein the fan assembly is adapted to draw in fluid through the first heat transfer section and the fluid flow augmenting device is adapted to induce the second fluid flow rate through the second heat transfer section and direct the augmented fluid flow to impinge on the heat transfer system via the fluid outlet.

23. The fluid circulation system of claim 22, wherein the heat transfer system includes a support member adapted to create a partition between the first heat transfer section and the second heat transfer section, and wherein the fan assembly and the fluid flow augmenting device are supported on the support member.

24. The fluid circulation system of claim 23, wherein the heat transfer system further includes a bell mouth radius disposed between the support member and the fluid inlet of the fluid flow augmenting device, the bell mouth radius being adapted to direct the fluid flow from the fan assembly into the first fluid directing structure and the internal volume of the fluid flow augmenting device.

25. The fluid circulation system of claim 23, wherein the heat transfer system further includes a plurality of partition walls extending longitudinally downwardly from the support member and adapted to create partitions in the first heat transfer section, each of the plurality of partition walls being spaced apart from one another to form vanes for directing the fluid flow into the fluid inlet of the fluid flow augmenting device.

26. The fluid circulation system of claim 19 further comprising one or more flow-turning structures positioned around the fluid flow augmenting device and adapted to redirect the second fluid flow to be aligned with the fluid outlet.

27. The fluid circulation system of claim 19, wherein the fan assembly includes one or more fans arranged in one of the following configurations:
a) one or more fans positioned upstream of the fluid flow augmenting device;
b) one or more fans positioned downstream of the fluid flow augmenting device;
c) one or more fans positioned upstream of the fluid flow augmenting device and another one or more fans positioned inside the fluid flow augmenting device; or
d) one or more fans positioned upstream of the fluid flow augmenting device and another one or more fans positioned downstream of the fluid flow augmenting device.

28. (canceled)

29. (canceled)

30. The fluid circulation system of claim 19, wherein the annular body includes one or more external walls adapted to define an annular space with respect to a housing of the heat transfer system, the annular space being adapted to entrain a third fluid flow having a third fluid flow rate around a perimeter of the fluid flow augmenting device to be combined with the augmented fluid flow prior to being exhausted via the fluid outlet.

31. The fluid circulation system of claim 19, wherein the annular body includes one or more external walls extending between the longitudinal ends and adapted to define a periphery of the fluid flow augmenting device, and wherein the first fluid directing structure includes one or more conduits defined by the respective one or more external walls, the conduits being positioned about the periphery and fluidly connected to the fluid inlet to receive the first fluid flow.

32. The fluid circulation system of claim 31, wherein each of the one or more conduits includes a hollow cross-sectional profile having one or more fluid contact surfaces adapted to guide the first fluid flow into the respective conduits, the internal volume of the fluid flow augmenting device and towards the fluid outlet.

33. The fluid circulation system of claim 31, wherein the one or more conduits are spaced apart and angled with respect to one another to define the second fluid directing structure therebetween.

34. The fluid circulation system of claim 19, wherein each of the one or more ducts has a closed end proximal to the fluid inlet and an open end proximal to the fluid outlet, each of the one or more ducts having an axis of symmetry angled downstream with respect to the longitudinal axis of the fluid flow augmenting device.

35. The fluid circulation system of claim 34, wherein the axis of symmetry of each of the one or more ducts is angled downstream by an angle within the range of 10 degrees and 80 degrees with respect to the longitudinal axis of the fluid flow augmenting device.

36. The fluid flow augmenting device of claim 19, wherein the one or more ducts are positioned in one of the following configurations:
a) each of the one or more ducts beings positioned at an equal angular distance from one another and having the closed end positioned at an equal linear distance from the fluid source;
b) each of the one or more ducts being positioned at an unequal angular distance from one another and having the closed end positioned at an equal linear distance from the fluid source; and
c) one or more of the ducts having the closed end positioned at an unequal linear distance from the fluid source.

37. The fluid circulation system of claim 19, wherein the fluid outlet of the fluid flow augmenting device defines an exhaust edge for exhausting the augmented fluid flow therefrom, the exhaust edge including one or more of mixing lobes, scalloped edges, elliptical pattern, partial ellipse, and one or more chevrons having a scalloped pattern.

38. The fluid circulation system of claim 19, wherein one or more of the fluid inlet, the fluid outlet, the first fluid directing structure, and the second fluid directing structure includes rounded edges to provide smooth fluid flow therethrough.

39. The fluid circulation system of claim 19, wherein the second fluid directing structure may be in the form of one or more of an airfoil, a coanda surface, a venturi, an aspirating nozzle; an ejector, an injector, and an eductor.

40. The fluid circulation system of claim 19, wherein the fluid flow augmenting device further comprising one or more internal partitions positioned within the internal volume, each of the one or more internal partitions being angled to define an aerodynamic profile and adapted to complement and align with a profile of the second fluid directing structure.

41. The fluid circulation system of claim 19, wherein the annular body of the fluid flow augmenting device includes a plurality of alternating lobes, each lobe defining a respective crest and trough.

42. The fluid circulation system of claim 31, wherein the annular body defines a plurality of external fluid channels each being defined between two crests and a plurality of internal fluid channels each being defined between two troughs, and wherein the first fluid directing structure includes the plurality of internal fluid channels and the second fluid directing structure includes the plurality of external fluid channels.

43. The fluid circulation system of claim 19, wherein the exhaust assembly:
includes a first exhaust stack section fluidly coupled to the fluid outlet of the fluid flow augmenting device and a second exhaust stack section fluidly coupled to the first stack section, the second exhaust stack section defining a relief angle with respect to the first exhaust stack section to define a velocity reducing section adapted to create a velocity reduction in the exhausted fluid received from the fluid flow augmented device and exited via an exhaust outlet;
includes an exhaust stack fluidly connected to the fluid outlet of the fluid flow augmenting device, a wind band mounted on the exhaust assembly, and a fluid diode positioned inside the exhaust stack, the wind band being adapted to deflect the exhaust flow when a crosswind impinges on the exhaust assembly and the fluid diode being adapted to redirect a fluid flow to align with the exhaust flow in a downwind situation;
includes an exhaust nozzle to exhaust the augmented fluid flow from the fluid flow augmenting device; or,
includes an acoustic emissions reducing material applied on at least a portion thereof.

44. (canceled)

45. (canceled)

46. (canceled)

47. The fluid circulation system of claim 19 comprising a plurality of fluid flow augmenting devices arranged in a series or a parallel configuration with respect to the fan assembly and wherein the augmented fluid flows from each of the plurality of fluid flow augmenting devices are combined to form a final augmented fluid flow having a final combined fluid flow rate.

48. (canceled)

49. The fluid circulation system of claim 19 further comprising:
one or more sensors for measuring fluid flow rate, pressure, and/or temperature, the one or more sensors being mounted on the fluid flow augmenting device, wherein each of the sensors is adapted to monitor one or more parameters of the fluid flowing through the fluid circulation system; and
a controller communicably coupled to the one or more sensors, the fan assembly and the fluid flow augmenting device, the controller being configured to adjust a fan speed of the fan assembly based on the monitored one or more parameters.

50. (canceled)
